(19) United States
(12) Patent Application Publication
(10) Pub. No.: US 2004/0119867 A1
(43) Pub. Date: Jun. 24, 2004

(54) Imaging apparatus, controlling method thereof and finder

(75) Inventors: Kimihiko Nishioka, Tokyo (JP); Masaaki Daigaku, Tokyo (JP)

Correspondence Address: WESTERMAN, HATTORI, DANIELS & ADRIAN, LLP, 1250 CONNECTICUT AVENUE, NW, SUITE 700, WASHINGTON, DC, 20036, US

(73) Assignee: OLYMPUS OPTICAL CO., LTD., Tokyo (JP)

(21) Appl. No.: 10/671,827

(22) Filed: Sep. 29, 2003

(30) Foreign Application Priority Data
Oct. 1, 2002 (JP) 2002-288263
Oct. 1, 2002 (JP) 2002-288264
Oct. 1, 2002 (JP) 2002-288472

(51) Int. Cl. H04N 5/222

(52) U.S. Cl. 348/333.01

(57) ABSTRACT

Disclosed herein is an imaging apparatus for taking images including: an optical finder for visually confirming the image to be taken; a variable configuration mirror having a reflecting surface variable in configuration upon a conduction of electricity for performing an optical adjustment of the optical finder based on change in the configuration of the reflecting surface; and a control section for effecting control so as to conduct electricity to the variable configuration mirror when an operation mode of the imaging apparatus is set to a specific mode.

This application claims benefit of Japanese Applications No. 2002-288263 filed in Japan on Oct. 1, 2002, No. 2002-288264 filed in Japan on Oct. 1, 2002 and No. 2002-288472 filed in Japan on Oct. 1, 2002, the contents of which are incorporated by this reference.

### BACKGROUND OF THE INVENTION

The present invention relates to imaging apparatus and controlling method thereof and finders in which a variable configuration mirror is used to reduce power consumption.

Generally, a reduction in power consumption is demanded at every driving part in the imaging apparatus such as a digital camera or video movie camera to be driven by battery. In particular, a reduction in power consumption results in an extended time during which the apparatus can be operated and leads to a reduced apparatus size based on reduced battery size. Here the power consumption of lens driving motors for zoom and autofocus provided in the imaging optical system and optical finder optical system is not negligible. To reduce the power consumption of the apparatus as a whole, it is important to reduce the power consumption due to the driving of lenses.

The image taking system of an imaging apparatus such as a digital camera tends to be provided with a variable power (zoom) function. The variable power function makes it possible to set an angle of view at will. Two types of variable power means are: optical variable power means for changing focal distance by moving a part of lenses within the image taking optical system; and electronic variable power means (electronic zoom) where a portion of image data is clipped and the clipped image is subjected to an image processing such as interpolation to make an enlarged image. Further, attempts are made to achieve a wider range of variable magnifying power by using the optical variable power means for low magnifications and, for high magnifications, by using the electronic variable power means in a manner superimposed on the optical variable power means.

Of the optical finder of an imaging apparatus having a variable power function, the angle of view is required to match the angle of view of the image taking system. For this reason, a part of the drive mechanism of the variable power means of the image taking system and the variable power mechanism of the finder system are connected to each other so that the variable power mechanism of the optical finder is caused to move in connection with the power varying movement of the variable power means of the image taking system to achieve an agreement between the angles of view of the two. Since, however, an optical finder cannot correspond to the electronic zoom of the image taking system, there are cases of calling attention by displaying an indication that the angles of view do not coincide when the electronic zoom is used.

Further, an optical finder is usually somewhat out of focus, since its focusing position is not corrected. This is because the providing of a focus correcting mechanism in the optical finder results in an increased size thereof. Also, the providing of a mechanism to be operated for example in connection with the focusing mechanism of the taking lens results in a complicated construction.

Generally, of those imaging apparatus such as film cameras and digital cameras, many are provided with an optical finder or a view finder having an incorporated LCD for confirming an image when the image is to be taken. Among these finders, some are provided with a diopter adjusting mechanism which makes an observation of clear image possible by correcting the individual difference in the photographer's visual acuity. There are two types of diopter adjusting mechanism: hand-operated type where a diopter adjusting lens is manually moved; and electrically-driven type where it is moved by motor.

Of the above described electrically-driven type, one is disclosed in Japanese patent application laid-open Hei-8-328085 in which a plurality of diopter values are previously stored to memory of the camera and these are called to readily effect a diopter adjustment. This type has an advantage that a diopter adjusted to the visual acuity of each individual can be readily remembered even when one apparatus is shared by a plurality of persons.

The present applicant has proposed for example in Japanese patent application laid-open hei-11-317894 an optical system using a variable configuration mirror, a new system to replace the conventional system where lenses are driven by motor, as the means for achieving a reduction in power consumption of an optical system in the taking system or optical finder. An example of the variable configuration mirror proposed in the above-mentioned publication will now be described by way of FIGS. 1A and 1B. FIG. 1A is a top view; and FIG. 1B is a sectional view along X-X′ in FIG. 1A. As shown in FIGS. 1A and 1B, a variable configuration mirror 101 has a ring-like support wall 103 projected from one side surface of a circular disk base board 102. Fixed electrodes consisting of three peripheral electrodes 104A, 104B, 104C and one center electrode 104D are disposed within the region surrounded by the ring-like support wall 103. A peripheral portion of mirror body 105 is joined and fixed to the opening end of the ring-like support wall 103.

The three peripheral electrodes 104A, 104B, 104C each are an electrode plate in the form of a circular arc disposed in substantially every 120-dgree angular range. The center electrode 104D is in the form of a circular disk-like electrode plate disposed within a circular region occurring at the center of the three peripheral electrodes 104A, 104B, 104C. The pattern of the fixed electrodes includes but not limited to the one illustrated and those of various other forms can be suitably used. The mirror body 105 is formed such that aluminum serving as both a movable electrode and a reflecting member (mirror surface) is adhered to an outer surface of a circular disk which is formed for example of a polyimide resin.

When a predetermined voltage is applied between the fixed electrodes (104A to 104D) and the movable electrode (mirror body 105) of thus constructed variable configuration mirror 101, the curved configuration of the reflecting surface (mirror body 105) is variably controlled by the electrostatic force thereof. Accordingly, the applied voltage is controlled from an external source so as to attain a suitable radius of curvature of the reflecting surface.

Another example of the construction of the variable configuration mirror will now be described by way of FIGS. 2A and 2B. The variable configuration mirror in this example is of the electromagnetically driven type. FIG. 2A is a side sectional view; and FIG. 2B shows the back side of a mirror body. A variable configuration mirror 201 of the electromagnetically driven type has a ring-like support wall 203 projected from one side surface of a base plate 202. A plurality of permanent magnets 204 are disposed within the region surrounded by the ring-like support wall 203. A peripheral portion of mirror body 205 is joined and fixed to an opening end of the ring-like support wall 203. The mirror body 205 is constructed for example by a polyimide resin as a circular disk which can be changed in configuration. A plurality of coils 206 are formed on the inside surface (back side) thereof, and a reflecting film 207 to which aluminum is adhered is formed on the outside surface thereof. A control current is supplied from an external drive circuit 208 to each coil 206 respectively through a lead wire.

By supplying suitably controlled currents from the external drive circuit 208 to the coils 206 of the mirror body 205 of thus constructed variable configuration mirror 201, the configuration of the mirror body 205 is changed into a concave or convex by the attraction or repulsion due to an electromagnetic force occurring between the currents flowing through the coils 206 and the magnetic field of the permanent magnets 204.

The coils 206 provided on the mirror body 205 are formed by thin films so that they can be readily made. At the same time, since the rigidity of the coils themselves can be lowered, the mirror body 205 can be more readily changed in configuration. It is also possible to provide the permanent magnets on the mirror body and to dispose the coils on the base board. In addition, one using a piezoelectric material in the mirror body so as to change its configuration based on piezoelectric effect can be used as the construction of the variable configuration mirror.

Thus constructed variable configuration mirror can be disposed within an optical system of camera so that the radius of curvature of the mirror body can be changed to effect focusing or variable power operation by controlling the applied voltage or currents. It should be noted that the shape of the mirror body is not limited to a circle, and an oval can also be used. The variable configuration mirror constructed as the above has two distinct features: its power consumption is lower as compared to the conventional lens optical system to be driven by motor; and the variable configuration mirror is substantially soundless, whereas a large motor sound and noise at its transmitting system are caused in the conventional motor-driven lens optical system.

Further, the present applicant has made various suggestions in Japanese patent application laid-open No.2002-122784 with respect to the optical construction to be used in an image taking optical system and the optical construction to be used in an optical finder having a variable configuration mirror mounted thereon.

### SUMMARY OF THE INVENTION

It is an object of the present invention to provide imaging apparatus and controlling method thereof and optical finders in which the conduction of electricity can be suitably controlled of the imaging apparatus having an incorporated optical system having a variable configuration mirror so that a further reduction in power consumption can be achieved. It is another object of the invention to provide imaging apparatus and controlling method thereof in which a variable configuration mirror is suitably controlled in connection with a variable power adjustment of image taking system in the imaging apparatus having an optical finder having the variable configuration mirror mounted thereon. It is a further object of the invention to provide imaging apparatus and finder in which diopter adjustment of the finder having a variable configuration mirror mounted thereon capable of reducing power consumption can be controlled more efficiently.

In a first aspect of the invention, there is provided an imaging apparatus for taking image including: an optical finder for visually confirming image to be taken; a variable configuration mirror having a reflecting surface variable in configuration upon conduction of electricity for performing an optical adjustment of the optical finder based on change in the configuration of the reflecting surface; and a control section for effecting control so as to conduct electricity to the variable configuration mirror when an operation mode of the imaging apparatus is set to a specific mode.

The imaging apparatus according to the first aspect may employ a construction where the control section effects control so as to conduct electricity to the variable configuration mirror in accordance with predetermined instructions when the operation mode of the imaging apparatus is set to an image taking mode.

The imaging apparatus according to the first aspect may employ a construction where the control section effects control so as not to conduct electricity to the variable configuration mirror when the operation mode of the imaging apparatus is set to a through image displaying mode for displaying a through image onto an image display means.

In the imaging apparatus according to the first aspect, the variable configuration mirror may constitute a part of an optical system of the optical finder.

The imaging apparatus according to the first aspect may employ a construction where the variable configuration mirror adjusts a variable power ratio of the optical finder.

The imaging apparatus according to the first aspect may employ a construction where the variable configuration mirror adjusts a focal point of the optical finder.

The imaging apparatus according to the first aspect may employ a construction where the variable configuration mirror adjusts a diopter of the optical finder.

The imaging apparatus according to the first aspect may employ a construction where a plurality of units of the variable configuration mirror are provided to effect the optical adjustment of the optical finder.

In a second aspect of the invention, there is provided a controlling method of imaging apparatus for taking image, including a step of conducting electricity to a variable configuration mirror for performing an optical adjustment of an optical finder based on configuration change of a reflecting surface thereof due to conduction of electricity when an operation mode of the imaging apparatus is being set to a specific mode.

In a third aspect of the invention, there is provided an imaging apparatus including: an image taking section for taking image; a variable configuration mirror to be used for the image taking section having a reflecting surface variable in configuration upon conduction of electricity for performing an optical adjustment of the image taking section by change in the configuration of the reflecting surface; an optical finder for visually confirming image to be taken; a variable configuration mirror to be used for the optical finder having a reflecting surface variable in configuration upon conduction of electricity for performing an optical adjustment of the optical finder by change in the configuration of the reflecting surface; and a control section for effecting control so as to avoid a reciprocal overlap of timings at which electricity is conducted respectively to the variable configuration mirror to be used for the image taking section and to the variable configuration mirror to be used for the optical finder.

In a fourth aspect of the invention, there is provided an imaging apparatus including: an image taking section for taking image; a variable configuration mirror to be used for the image taking section having a reflecting surface variable in configuration upon conduction of electricity for performing an optical adjustment of the image taking section by change in the configuration of the reflecting surface; an optical finder for visually confirming image to be taken; a variable configuration mirror to be used for the optical finder having a reflecting surface variable in configuration upon conduction of electricity for performing an optical adjustment of the optical finder by change in the configuration of the reflecting surface; and a control section for, in controlling the conduction of electricity to the variable configuration mirror to be used for the image taking section and to the variable configuration mirror to be used for the optical finder, effecting control so as to avoid an overlap of the conduction of electricity for at least one variable configuration mirror of the variable configuration mirrors with the conduction of electricity for the other variable configuration mirror.

The imaging apparatus according to the fourth aspect may employ a construction where the control section effects control so that the conduction of electricity for each one of all the variable configuration mirrors does not overlap that for another.

In a fifth aspect of the invention, there is provided a controlling method of imaging apparatus, including a step of controlling a plurality of variable configuration mirrors that are variable configuration mirrors to be used for an image taking section for performing an optical adjustment of the image taking section by change in configuration of a reflecting surface caused by conduction of electricity and variable configuration mirrors to be used for an optical finder for performing an optical adjustment of the optical finder by change in configuration of a reflecting surface caused by conduction of electricity such that the conduction of electricity for at least one variable configuration mirror of the plurality of the variable configuration mirrors does not overlap the conduction of electricity for the other configuration mirrors.

In a sixth aspect of the invention, there is provided an imaging apparatus for taking image, including: an optical finder for visually confirming image to be taken; a variable configuration mirror having a reflecting surface variable in configuration upon conduction of electricity for performing an optical adjustment of the optical-finder by change in the configuration of the reflecting surface; and a control means for effecting control so as to conduct electricity to the variable configuration mirror when an operation mode of the imaging apparatus is set to a specific mode.

In a seventh aspect of the invention, there is provided an optical finder for visually confirming image to be taken, including: a plurality of variable configuration mirror having a reflecting surface variable in configuration upon conduction of electricity for performing an optical adjustment by change in the configuration of the reflecting surface; and a control section for controlling the conduction of electricity so that the periods during which electricity is conducted respectively to the plurality of variable configuration mirrors do not overlap each other.

In an eighth aspect of the invention, there is provided an optical finder for visually confirming image to be taken, including: a variable configuration mirror to be used for the optical finder constituting a part of the optical system of the optical finder and having a reflecting surface variable in configuration upon conduction of electricity for performing an optical adjustment by change in the configuration of the reflecting surface; and a control section for controlling the conduction of electricity so as to retain the configuration of the reflecting surface to be changed in configuration upon conduction of electricity of the variable configuration mirror to a predetermined configuration within a permissible range.

The optical finder according to the eighth aspect may employ a construction where the control section effects control so as to conduct electricity to the variable configuration mirror at predetermined intervals to retain the configuration of the reflecting surface to a predetermined configuration within a permissible range.

The optical finder according to the eighth aspect may employ a construction having a plurality of the variable configuration mirror, where the control section controls the conduction of electricity so that the periods during which electricity is conducted respectively to the plurality of the variable configuration mirrors do not overlap each other.

In a ninth aspect of the invention, there is provided an imaging apparatus including: an image taking section for taking image; a variable configuration mirror to be used for the image taking section having a reflecting surface variable in configuration upon conduction of electricity for performing an optical adjustment of the image taking section by change in the configuration of the reflecting surface; an optical finder for visually confirming image to be taken; a variable configuration mirror to be used for the optical finder having a reflecting surface variable in configuration upon conduction of electricity for performing an optical adjustment of the optical finder by change in the configuration of the reflecting surface; and a control section for controlling the conduction of electricity to the variable configuration mirror to be used for the image taking section and to the variable configuration mirror to be used for the optical finder. The control section effects control so that an intermittent conduction of electricity for retaining the configuration of the reflecting surface of the variable configuration mirrors to a predetermined configuration within a permissible range is repeated in such a manner that an intermittent cycle for the variable configuration mirror to be used for the image taking section is shorter as compared to that for the variable configuration mirror to be used for the optical finder.

In a tenth aspect of the invention, there is provided an imaging apparatus including: an image taking means for taking image; a variable configuration mirror to be used for the image taking means having a reflecting surface variable in configuration upon conduction of electricity for performing an optical adjustment of the image taking means by change in the configuration of the reflecting surface; an optical finder for visually confirming image to be taken; a variable configuration mirror to be used for the optical finder having a reflecting surface variable in configuration upon conduction of electricity for performing an optical adjustment of the optical finder by change in the configuration of the reflecting surface; and a control means for controlling the conduction of electricity to the variable configuration mirror to be used for the image taking means and to the variable configuration mirror to be used for the optical finder. The control means effects control so that an intermittent conduction of electricity for retaining the configuration of the reflecting surface of the variable configuration mirrors to a predetermined configuration within a permissible range is repeated in such a manner that an intermittent cycle for the variable configuration mirror to be used for the image taking means is shorter as compared to that for the variable configuration mirror to be used for the optical finder.

In an eleventh aspect of the invention, there is provided an imaging apparatus including: an image taking section having a variable power section; a variable power instructing section for giving an instruction for change in variable magnification to the variable power section; an optical finder for visually confirming image to be taken; a variable configuration mirror to be used for the optical finder having a reflecting surface variable in configuration upon conduction of electricity for performing a variable power adjustment by change in the configuration of the reflecting surface; and a control section for controlling a variable magnification of the variable configuration mirror to be used for the optical finder in accordance with an instruction of the variable power instructing section.

The imaging apparatus according to the eleventh aspect may employ a construction where the variable power section of the image taking section has an optical variable power section and an electronic variable power section and a maximum variable magnification of the variable configuration mirror to be used for the optical finder is set equal to a maximum variable magnification of the image taking section obtained by combining the electronic variable power section to the optical variable power section.

The imaging apparatus according to the eleventh aspect may employ a construction where the variable power section of the image taking section has an optical variable power section and an electronic variable power section and the control section controls a variable magnification of the variable configuration mirror to be used for the optical finder in accordance with a variable magnification obtained by totaling the respective variable magnifications of the optical variable power section and the electronic variable power section.

The imaging apparatus according to the eleventh aspect may employ a construction where the variable power section of the image taking section has a variable configuration mirror having a reflecting surface variable in configuration upon conduction of electricity so as to perform a variable power adjustment by change in the configuration of the reflecting surface of the variable configuration mirror.

In a twelfth aspect of the invention, there is provided a controlling method of imaging apparatus including an image taking section having an optical variable power section and an electronic variable power section and an optical finder for visually confirming image to be taken, including the steps of: controlling the variable power of the image taking section by combining the optical variable power section and the electronic variable power section in accordance with an instruction of change in a variable magnification to the image taking section; and controlling a variable magnification of a variable configuration mirror provided in the optical finder having a reflecting surface variable in configuration upon conduction of electricity for performing a variable power adjustment by change in the configuration of the reflecting surface in accordance with the combined variable magnification of the image taking section.

In a thirteenth aspect of the invention, there is provided an imaging apparatus including: an image taking section for taking image; a taking system optical variable power section for adjusting variable magnification of image to be taken by movement of at least one lens along an optical axis thereof; an optical finder for visually confirming image to be taken; and a finder variable power section for changing a magnification of the image to be visually confirmed, formed as a combination of two variable power adjusting sections that are a lens variable power adjusting section based on movement of a lens along the optical axis thereof and a mirror variable power adjusting section based on change in configuration of a reflecting surface of a variable configuration mirror having the reflecting surface variable in configuration upon conduction of electricity. A maximum variable magnification of the taking system optical variable power section is set equal to a maximum variable magnification of the lens variable power adjusting section of the finder variable power section.

The imaging apparatus according to the thirteenth aspect may employ a construction further including an electronic variable power section which electronically changes a magnification of the image to be taken and of which a maximum variable magnification is set equal to a maximum variable magnification of the mirror variable power adjusting section.

In a fourteenth aspect of the invention, there is provided an imaging apparatus including: an image taking section for taking image; a taking system optical variable power section for changing a magnification of the image to be taken, formed as a combination of two variable power adjusting sections that are a lens variable power adjusting section based on movement of a lens along an optical axis thereof and a mirror variable power adjusting section based on change in configuration of a reflecting surface of a variable configuration mirror having the reflecting surface variable in configuration upon conduction of electricity; an optical finder for visually confirming image to be taken; and a finder variable power section for changing a magnification of the image to be visually confirmed, formed as a combination of two variable power adjusting sections that are a lens variable power adjusting section based on movement of a lens along an optical axis thereof and a mirror variable power adjusting section based on change in configuration of a reflecting surface of a variable configuration mirror having the reflecting surface variable in configuration upon conduction of electricity. A maximum variable magnifications of the respective lens variable power adjusting sections of the taking system optical variable power section and the finder variable power section are set to be equal to each other.

In a fifteenth aspect of the invention, there is provided an imaging apparatus including: an image taking section for taking image; a taking system optical variable power section for changing a magnification of the image to be taken, formed as a combination of two variable power adjusting sections that are a lens variable power adjusting section based on movement of a lens along an optical axis thereof and a mirror variable power adjusting section based on change in configuration of a reflecting surface of a variable configuration mirror having the reflecting surface variable in configuration upon conduction of electricity; an optical finder for visually confirming the image to be taken; and a finder variable power section for changing a magnification of the image to be visually confirmed, formed as a combination of two variable power adjusting sections that are a lens variable power adjusting section based on movement of a lens along an optical axis thereof and a mirror variable power adjusting section based on change in configuration of a reflecting surface of a variable configuration mirror having the reflecting surface variable in configuration upon conduction of electricity. A maximum variable magnifications of the respective mirror variable power adjusting sections of the taking system optical variable power section and the finder variable power section are set to be equal to each other.

In a sixteenth aspect of the invention, there is provided an imaging apparatus including: an image taking section for taking image; a focus detecting section for effecting focus detection; a taking focus section for adjusting a focal point of the image taking section; an optical finder for visually confirming the image to be taken; a variable configuration mirror having a reflecting surface variable in configuration upon conduction of electricity for adjusting a focal point of the optical finder by change in the configuration of the reflecting surface; and a control section for controlling the taking focus section and the variable configuration mirror based on an outcome of the focus detection.

The imaging apparatus according to the sixteenth aspect may employ a construction where the control section controls the variable configuration mirror so as to additionally effect a variable power adjustment of the optical finder.

The imaging apparatus according to the sixteenth aspect may employ a construction where the taking focus section has a variable configuration mirror having a reflecting surface variable in configuration upon conduction of electricity so as to adjust the focal point by change in the configuration of the reflecting surface of the variable configuration mirror.

The imaging apparatus according to the sixteenth aspect may employ a construction further including an image display section for electrically displaying the image to be taken so that, if a through image is being displayed on the image display section, the control section effects control so as to adjust the focal point only of the variable configuration mirror of the taking focus section and does not effect a focal point adjustment of the variable configuration mirror of the optical finder.

The imaging apparatus according to the sixteenth aspect may employ a construction where the focus detecting section detects focus by a hill climbing method (contrast detection method), and the control section, during the focus detection by the focus detecting section, effects control so as to change the focal point adjustment of the taking focus section in connection with the focus detection and to cause the operation of the variable configuration mirror of the optical finder to be interrupted.

In a seventeenth aspect of the invention, there is provided an imaging apparatus including: an image taking means for taking image; a focus detecting means for effecting focus detection; a taking focus means for adjusting a focal point of the image taking means; an optical finder for visually confirming the image to be taken; a variable configuration mirror having a reflecting surface variable in configuration upon conduction of electricity for adjusting focal point of the optical finder by change in the configuration of the reflecting surface; and a control means for controlling the taking focus means and the variable configuration mirror based on an outcome of the focus detection.

In an eighteenth aspect of the invention, there is provided an imaging apparatus including: an image taking section for taking image; a finder for visually confirming the image to be taken; a variable configuration mirror having a reflecting surface variable in configuration upon conduction of electricity capable of adjusting diopter of the finder by change in the configuration of the reflecting surface; a storage section for storing an information relating to the configuration of the variable configuration mirror corresponding to the diopter adjustment; and a control section for controlling the variable configuration mirror to a predetermined configuration in accordance with the stored information.

The imaging apparatus according to the eighteenth aspect may employ a construction where the storage section stores information relating to a plurality of configurations as the information relating to the configuration of the variable configuration mirror.

The imaging apparatus according to the eighteenth aspect may employ a construction where the control section controls the variable configuration mirror to a predetermined configuration based on the stored information in accordance with a turning ON of a power supply of the imaging apparatus. It should be noted that the stored information here includes a default of diopter adjusting values at the time of shipment from factory.

The imaging apparatus according to the eighteenth aspect may employ a construction where the control section controls the variable configuration mirror to a predetermined configuration based on a stored information when the imaging apparatus is in a mode capable of taking image.

The imaging apparatus according to the eighteenth aspect may employ a construction where a diopter condition of the finder is brought to a standard diopter condition by the reflecting surface configuration of the variable configuration mirror in a condition where electricity is not conducted. Here, while the reflecting surface configuration of the variable configuration mirror in the condition without conduction of electricity is generally a flat shape, a previous forming thereof into a non-flat shape is also possible. Further the standard diopter refers to the diopter (diopter corrected by glasses if eyeglasses are worn) of an average photographer, for example, of the order of −1 diop to −4 diop. Accordingly, the spirit of the substance of the above construction is that the reflecting surface configuration of the variable configuration mirror at the time without conduction of electricity is designed so as to achieve a standard diopter of the order of −1 diop to −4 diop by a combination with other finder optical system such as lens.

In the imaging apparatus according to the eighteenth aspect, the finder may be an optical finder.

The imaging apparatus according to the eighteenth aspect may employ a construction where the variable configuration mirror, at the same time of diopter adjustment, adjusts a focal point of the finder in accordance with a focal point adjustment of an image taking optical system provided at the image taking section.

The imaging apparatus according to the eighteenth aspect may employ a construction where the finder has a plurality of variable configuration mirrors so that a variable power adjustment of the finder can be effected in accordance with a variable power adjustment of an image taking optical system provided at the image taking section.

The imaging apparatus according to the eighteenth aspect may employ a construction where the mirror configurations of the plurality of variable configuration mirrors are respectively adjusted toward opposite direction from each other into a concave or into a convex.

In a nineteenth aspect of the invention, there is provided an imaging apparatus including: an image taking means for taking image; a finder for visually confirming image to be taken; a variable configuration mirror having a reflecting surface variable in configuration upon conduction of electricity capable of a diopter adjustment of the finder by change in the configuration of the reflecting surface; a storage means for storing information relating to the configuration of the variable configuration mirror corresponding to the diopter adjustment; and a control means for controlling the variable configuration mirror to a predetermined configuration in accordance with the stored information.

In a twentieth aspect of the invention, there is provided a finder for visually confirming image, the finder including: a variable configuration mirror having a reflecting surface variable in configuration upon conduction of electricity capable of a diopter adjustment of the finder by change in the configuration of the reflecting surface; a storage section for storing an information relating to the configuration of the variable configuration mirror corresponding to the diopter adjustment; and a control section for controlling the variable configuration mirror to a predetermined configuration in accordance with the stored information.

In a twenty-first aspect of the invention, there is provided a finder for visually confirming image including a variable configuration mirror having a reflecting surface variable in configuration upon conduction of electricity capable of a diopter adjustment of the finder by change in the configuration of the reflecting surface, where the diopter condition of the finder is brought to a standard diopter condition by the reflecting surface configuration of the variable configuration mirror in a condition where electricity is not conducted.

In a twenty-second aspect of the invention, there is provided an imaging apparatus including: an image taking section for taking image; a finder for visually confirming image to be taken; a variable configuration mirror having a reflecting surface variable in configuration upon conduction of electricity capable of a diopter adjustment of the finder by change in the configuration of the reflecting surface; and a control section for causing the configuration of the variable configuration mirror to be changed. The control section, when use of the finder is to be avoided, controls the variable configuration mirror so as to attain an unsuitable diopter thereof that is different from the diopter at the time of using the finder.

The imaging apparatus according to the twenty-second aspect may employ a construction where the control section effects control so as to result in the unsuitable diopter when an object distance is short.

The imaging apparatus according to the twenty-second aspect may employ a construction where the control section effects control so as to result in the unsuitable diopter at the time of taking an image by using an electronic zoom section.

In a twenty-third aspect of the invention, there is provided an optical apparatus including: a plurality of variable configuration mirror having a reflecting surface variable upon a conduction of electricity for performing an optical adjustment by change in the configuration of the reflecting surface; and a control section for controlling the conduction of electricity so that the periods during which electricity is conducted respectively to the plurality of variable configuration mirrors do not overlap each other.

In the optical apparatus according to the twenty-third aspect, the optical apparatus may be an imaging apparatus for taking an image of object.

In the optical apparatus according to the twenty-third aspect, the optical apparatus may be an observing apparatus for observing a subject.

In the optical apparatus according to the twenty-third aspect, the optical apparatus may be an image forming apparatus for forming an object image.

In a twenty-fourth aspect of the invention, there is provided an optical apparatus including: a lens variable power adjusting section for adjusting a magnification of an image to be formed by moving a lens or lens group; and a mirror variable power adjusting section for adjusting a magnification by a configuration of a reflecting surface of a variable configuration mirror having the reflecting surface variable in the configuration upon a conduction of electricity.

In the optical apparatus according to the twenty-fourth aspect, the optical apparatus may be an imaging apparatus for taking an image of object.

In the optical apparatus according to the twenty-fourth aspect, the optical apparatus may be an observing apparatus for observing a subject.

In the optical apparatus according to the twenty-fourth aspect, the optical apparatus may be an image forming apparatus for forming an object image.

### BRIEF DESCRIPTION OF THE DRAWINGS

FIGS. 1A and 1B show an example of the construction of a known variable configuration mirror.

FIGS. 2A and 2B show another example of the construction of a known variable configuration mirror.

FIG. 3 is a block diagram showing an overall construction of digital camera to which a first embodiment of the imaging apparatus according to the invention is applied.

FIGS. 4A to 4C show examples of the configuration of the electrostatic type first and second variable configuration mirrors A, B at respective zoom ratios in adjusting the zoom ratio of the taking optical system in the first embodiment.

FIGS. 5A to 5C show examples of the configuration of the electrostatic type first variable configuration mirror A in adjusting focus from near point to far point of the taking optical system in the first embodiment.

FIG. 6 shows characteristic curves of the voltages to be applied to the electrostatic type first and second variable configuration mirrors A, B at the time of adjusting the zoom ratio and of adjusting focus in the taking optical system in the first embodiment.

FIGS. 7A and 7B show examples of the configuration of third and fourth variable configuration mirrors C, D of the electromagnetically driven type at respective zoom ratios in adjusting the zoom ratio of the finder optical system in the first embodiment.

FIGS. 8A to 8C show examples of the configuration of the electromagnetically driven type third variable configuration mirror C in adjusting focus from near point to far point of the finder optical system in the first embodiment.

FIGS. 9A and 9B show examples of the configuration of the electromagnetically driven type third variable configuration mirror C in adjusting diopter of the finder optical system in the first embodiment.

FIG. 10 shows characteristic curves of the currents to be applied to the electromagnetically driven type third and fourth variable configuration mirrors C, D at the time of adjusting the zoom ratio and of adjusting focus of the finder optical system in the first embodiment.

FIGS. 11A and 11B show examples of the configuration of the electrostatic type third and fourth variable configuration mirrors C, D at respective zoom ratios in adjusting the zoom ratio of the finder optical system in the first embodiment.

FIGS. 12A to 12C show examples of the configuration of the electrostatic type third variable configuration mirror C in adjusting focus from near point to far point of the finder optical system in the first embodiment.

FIGS. 13A and 13B show examples of the configuration of the electrostatic type third variable configuration mirror C in adjusting diopter of the finder optical system of the first embodiment.

FIG. 14 shows characteristic curves of the voltages to be applied to the electrostatic type third and fourth variable configuration mirrors C, D at the time of adjusting the zoom ratio and of adjusting focus of the finder optical system in the first embodiment.

FIG. 15 is a flowchart showing a main routine to explain the operation of the digital camera according to the first embodiment shown in FIG. 3.

FIG. 16 is a flowchart showing the subroutine operation of First Mirror Control 1 in the flowchart shown in FIG. 15.

FIG. 17 is a timing chart showing the manner of the conduction of electricity at the time of zoom operation to the (electrostatic type) variable configuration mirrors to be used for the taking optical system and to be used for the finder optical system in First Mirror Control 1.

FIG. 18 is a flowchart showing the subroutine operation of Second Mirror Control 2 in the flowchart shown in FIG. 15.

FIG. 19 is a timing chart showing a manner of conducting electricity to retain the variable configuration mirrors (electrostatic type) of the taking optical system and of the finder optical system in Second Mirror Control 2.

FIG. 20 is a timing chart showing another manner of conducting electricity to retain the variable configuration mirrors (electrostatic type) of the taking optical system and of the finder optical system in Second Mirror Control 2.

FIGS. 21A and 21B are flowcharts showing the subroutine operation of AF control in the flowchart shown in FIG. 15.

FIG. 22 is a flowchart for explaining the operation mainly of the diopter adjustment of the digital camera according to the first embodiment shown in FIG. 3.

FIGS. 23A and 23B are block diagrams showing a finder section of the digital camera according to a second embodiment of the invention.

FIGS. 24A and 24B show the correspondence between the focus adjusting value and the diopter adjusting value corresponding to the changed configurations in the case of using the electrostatic type variable configuration mirror C in the second embodiment.

FIG. 25 is a block diagram showing a finder section of the digital camera according to a third embodiment of the invention.

FIGS. 26A and 26B show the correspondence between the focus adjusting value and the diopter adjusting value corresponding to the changed configurations in the case of using the electrostatic type variable configuration mirror C in the third embodiment.

FIG. 27 is a partially omitted block diagram showing the digital camera according to a fourth embodiment of the invention.

FIG. 28 is a characteristic diagram showing the correspondence between the image taking magnification of the taking system and the finder magnification in the fourth embodiment.

FIG. 29 is a partially omitted block diagram showing the digital camera according to a fifth embodiment of the invention.

FIG. 30 is a characteristic diagram showing the correspondence between the image taking magnification of the taking system and the finder magnification in the fifth embodiment.

FIG. 31 is a partially omitted block diagram showing the digital camera according to a sixth embodiment of the invention.

FIG. 32 is a characteristic diagram showing the correspondence between the image taking magnification of the taking system and the finder magnification in the sixth embodiment.

FIG. 33 is a block diagram showing a finder section of the digital camera according to a seventh embodiment of the invention.

FIGS. 34A and 34B show the correspondence between the changed configurations and the diopter adjusting values in the case of using the electrostatic type variable configuration mirror C in the seventh embodiment.

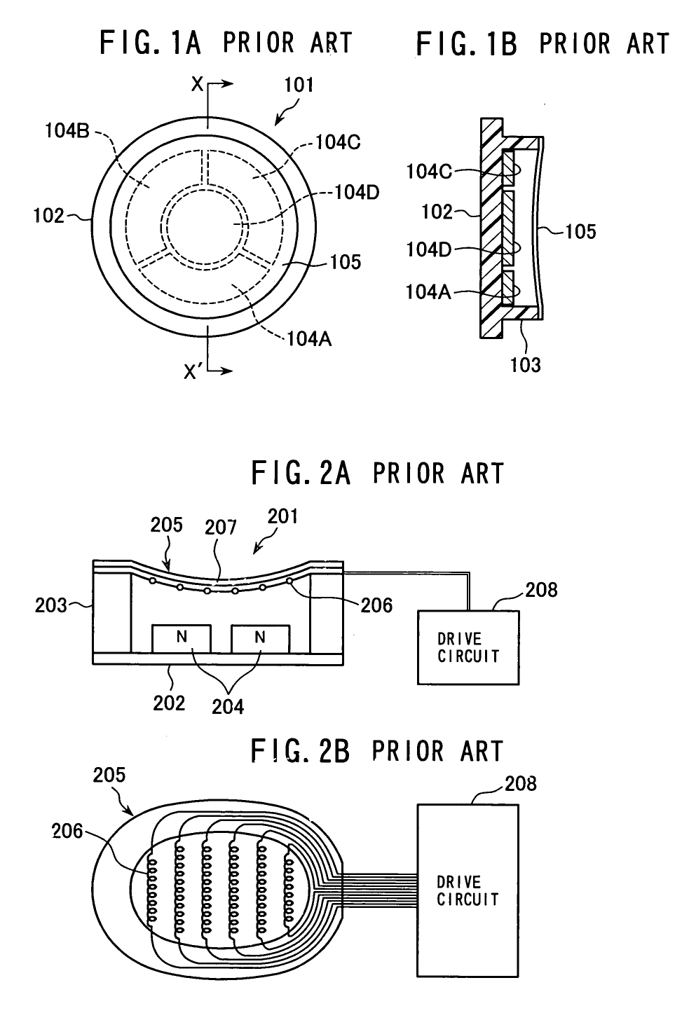

### DESCRIPTION OF THE PREFERRED EMBODIMENTS

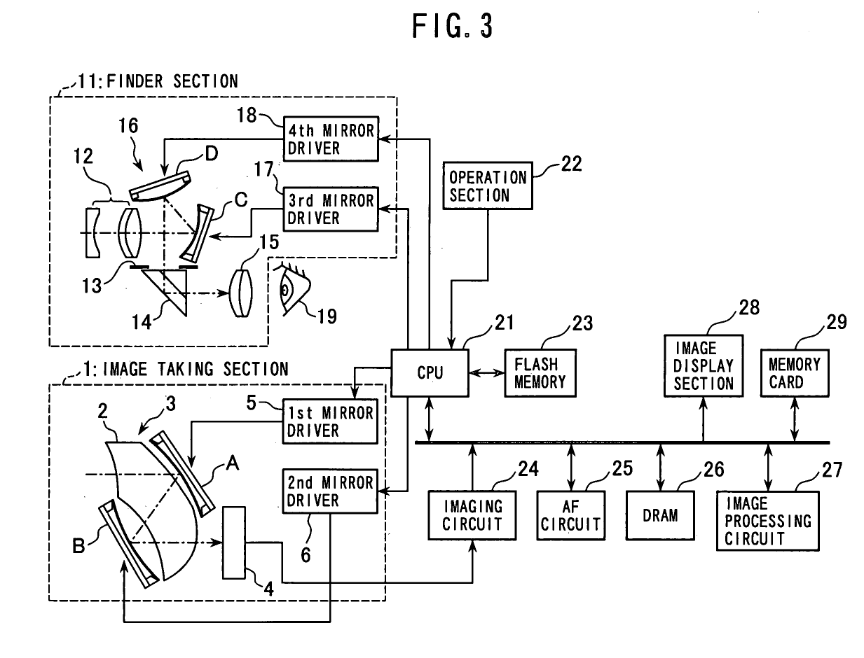

Some embodiments of the invention will now be described. FIG. 3 is a schematic block diagram showing an overall construction of the digital camera to which a first embodiment of the imaging apparatus according to the invention is applied. In FIG. 3, numeral 1 denotes an image taking section. The image taking section 1 includes: a taking optical system 3 having a free curved surface prism 2, a first variable configuration mirror A disposed in a manner facing a back side upper lens surface of the free curved surface prism 2, and a second variable configuration mirror B disposed in a manner facing a front side lower lens surface also of the free curved surface prism 2; an imaging device 4 disposed in a manner facing a back side lower lens surface of the free curved surface prism 2; and a first mirror driver 5 and second mirror driver 6 for respectively driving the first and second variable configuration mirrors A, B. While those of the electrostatic type of which change in the configuration is controlled by applied voltage are used here as the first and second variable configuration mirrors A, B of the above described taking optical system 3, it is also possible to use those of the electromagnetically driven type.

Referring to FIG. 3, numeral 11 denotes a finder section which includes a finder optical system 16 having: an objective lens 12 consisting of a concave lens and a convex lens; a third variable configuration mirror C disposed as facing the objective lens 12; a fourth variable configuration mirror D on which light reflected at the third variable configuration mirror C is incident; a roof prism 14 with a field stop 13 for obtaining an erected image by bending the line of sight through 90 degrees on which light reflected at the fourth variable configuration mirror D is incident; and an eyepiece lens 15 on which light coming from the roof prism 14 is incident. It further includes a third mirror driver 17 and fourth mirror driver 18 for driving the third and fourth variable configuration mirrors C, D. It should be noted that those of the electromagnetically driven type of which change in configuration is controlled by applied currents or those of the electrostatic type of which change in configuration is controlled by applied voltage are used as the third and fourth variable configuration mirrors C, D of the finder optical system 16.

The imaging signal processing system and the operation controlling system of the digital camera in the above embodiment includes: CPU 21 for controlling operation of each section of the camera; an operation section 22 having for example a power ON/OFF button, release button, zoom button (ganged optical/electronic system) and also effecting for example the inputting of a diopter adjusting value, switching of the diopter adjusting values, macro ON/OFF, electronic zoom ON/OFF operation; a flash memory 23 storing for example a camera program and a look-up table (LUT) concerning control data of each variable configuration mirror; an imaging circuit 24 for generating image data by processing imaging signals from the imaging device 4; AF circuit 25 for effecting a contrast AF processing using the image data; DRAM 26 for temporarily storing the image data; an image processing section 27 for effecting various image processing on the image data; an image display section 28 for displaying the image data; and a memory card 29 for recording the image data.

A general operation of the image taking section 1 and finder section 11 will now be described. An axial incident light ray incident on a front side upper lens surface of the free curved surface prism 2 of the taking optical system 3 passes through a back side upper lens surface thereof and is incident on and reflected by the first variable configuration mirror A. The reflected light therefrom is incident again on the back side upper lens surface and passes through a front side lower lens surface so as to be incident on and reflected by the second variable configuration mirror B. The reflected light therefrom is incident again on the front side lower lens surface and is transmitted through a back side lower lens surface to be incident on the imaging device 4.

Here the zoom ratio at the taking optical system is adjusted by voltages to be applied to the variable configuration mirrors A, B respectively by the first and second mirror drivers 5, 6 which are controlled through CPU 21 by an instruction input from the operation section 22. Further, focal point (focus) adjustment is effected by an adjustment of voltage to be applied to the variable configuration mirror A from the first mirror driver 5 which is controlled through CPU 21 based on AF signals from AF circuit 25.

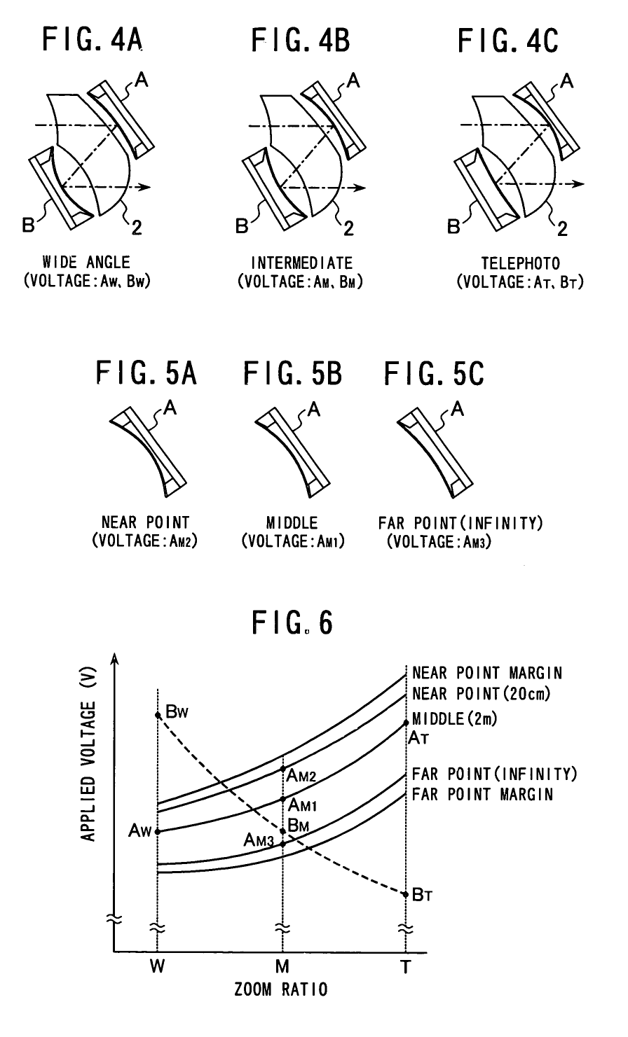

Shown in FIGS. 4A to 4C are examples of the configuration of the first and second variable configuration mirrors A, B at respective zoom ratios in adjusting the zoom ratio of the taking optical system. The voltages as will be described below are applied to the respective electrodes of the variable configuration mirrors A, B to obtain the predetermined configurations. A description will be given below by using the voltages applied to the center electrodes of the variable configuration mirrors A, B as the representative voltage. The voltage to be applied to each electrode corresponding to each configuration is stored to LUT in the flash memory 23. FIG. 4A shows the manner of the mirror body deformed into a wide-angle position as wide zoom voltages A_{W}, B_{W} are applied respectively to the first and second variable configuration mirrors A, B to bring the zoom ratio to a wide-angle value W. FIG. 4B shows the manner where it is deformed into an intermediate position as intermediate zoom voltages A_{M}, B_{M} are applied respectively to the first and second variable configuration mirrors A, B to bring the zoom ratio to an intermediate value M. FIG. 4C shows the manner where it is deformed into a telephoto position as telephoto zoom voltages A_{T}, B_{T} are applied respectively to the first and second variable configuration mirrors A, B to bring the zoom ratio to a telephoto value.

Examples of the configuration of the first variable configuration mirror A in adjusting focus from near point to far point in the taking optical system are shown in FIGS. 5A to 5C. FIG. 5A shows the manner of the mirror body deformed into a near point position as a voltage A_{M2} is applied to the first variable configuration mirror A to bring the focus to a near point (20 cm) at the zoom ratio of intermediate value M. FIG. 5B shows the manner where it is deformed into an intermediate position as a voltage A_{M1} is applied to the first variable configuration mirror A to bring the focus to an intermediate distance (2 m). FIG. 5C shows the manner where it is deformed into a far point position as a voltage A_{M3} is applied to the first variable configuration mirror A to bring the focus to a far point (infinity).

Shown in FIG. 6 are characteristic curves of the voltage to be applied respectively to the first and second variable configuration mirrors A, B at the time of adjusting the zoom ratio and adjusting focus in the taking optical system. In FIG. 6, the solid lines indicate voltage curves applied to the first variable configuration mirror A and the dotted line indicates a voltage curve applied to the second variable configuration mirror B. Each voltage value (voltage data) of these applied voltage characteristic curves is stored to the flash memory 23 in the form of a look-up table. All of the respective voltage values at all zoom ratios or at all focusing positions can be correspondingly stored as the voltage values (voltage data) of the look-up table. To save memory, however, it is also possible to store only those voltage values corresponding to the zoom ratio/focusing position at main points and to compute by interpolation those voltages corresponding to the points other than the main points. Further, as the voltage values, it is possible to store a separate voltage value for each of the fixed electrodes (4 for example) of each variable configuration mirror. Also to save memory, however, if deviation of applied voltages between the fixed electrodes is constant, it is also possible to store only the application voltage value for example to the electrode disposed at a center region and to compute by operation the application voltage values to the other electrodes (3 for example).

A general operation of the finder section 11 will now be described. At the finder section 11, an axial incident light ray incident on the objective lens 12 is incident on and reflected by the third variable configuration mirror C. The reflected light therefrom is incident on and reflected by the fourth variable configuration mirror D. The reflected light therefrom is incident on the roof prism 14 through the field stop 13 so as to be emitted as an erected image therefrom as bent through 90 degrees and then is incident on pupil 19 of the user through the eyepiece lens 15.

Here the zoom ratio adjustment at the finder optical system 16 is effected by an adjustment of currents or voltages applied to the third and fourth variable configuration mirrors C, D from the third and fourth mirror drivers 17, 18 which are controlled through CPU 21 by an instruction input from the operation section 22 in a similar manner as the zoom ratio adjustment of the taking optical system. In particular, if those of the electromagnetically driven type are used as the third and fourth variable configuration mirrors C, D, the zoom ratio adjustment at the finder optical system 16 is effected by an adjustment of currents to be applied thereto. If those of the electrostatic type are used, it is effected by an adjustment of voltages to be applied thereto. Further, focus adjustment is effected by an adjustment of currents (in the case of the electromagnetically driven type) or an adjustment of voltages (in the case of the electrostatic type) to be applied to the third variable configuration mirror C from the third mirror driver 17 which is controlled through CPU 21 based on AF signals from AF circuit 25 in a similar manner as the focus adjustment of the taking optical system. Furthermore, in the diopter adjustment of the finder optical system 16, the diopter is adjusted so as to achieve a predetermined diopter adjusting value corresponding to the visual acuity of each photographer by an adjustment of applied current or applied voltage to the variable configuration mirror C in a combination with an optical system other than the variable configuration mirror C.

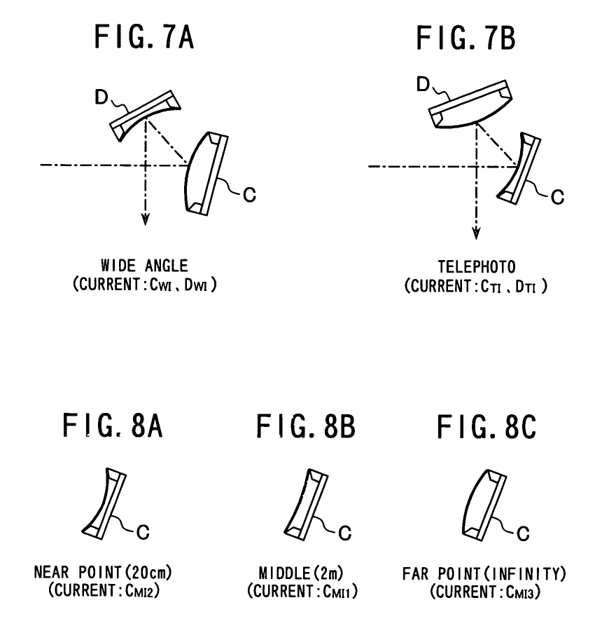

Shown in FIGS. 7A and 7B are examples of the configuration of the third and fourth variable configuration mirrors C, D at the two ends of zoom ratios in adjusting the zoom ratio in the case where those of the electromagnetically driven type are used as the variable configuration mirrors C, D of the finder optical system 16.

FIG. 7A shows the manner of the mirror body deformed into a wide-angle position as wide zoom currents C_{W1}, D_{W1} are caused to flow respectively to the third and fourth variable configuration mirrors C, D to bring the zoom ratio to a wide-angle value W. FIG. 7B shows the manner where it is deformed into a telephoto position as telephoto zoom currents C_{T1}, D_{T1} are caused to flow respectively to the third and fourth variable configuration mirrors C, D to bring the zoom ratio to a telephoto value T. In thus adjusting zoom ratio, the zoom ratio can be made greater and a variable power image having smaller aberration can be visually confirmed by respectively adjusting the configurations of the mirror body of the third and fourth variable configuration mirrors C, D so that they are formed into a concave or into a convex in the opposite direction from each other.

Shown in FIGS. 8A to 8C are examples of the configuration of the third variable configuration mirror C (in the case of the electromagnetically driven type) in adjusting focus from near point to far point in the finder optical system 16. FIG. 8A shows the manner of its deformation to a near point position as a current C_{M12} is caused to flow to the third variable configuration mirror C to bring the focus to a near point (20 cm) in the case where the zoom ratio is set to the intermediate value M. FIG. 8B shows the manner where it is deformed into an intermediate position as a current C_{M11} is caused to flow to the third variable configuration mirror C to bring the focus to an intermediate distance (2 m). FIG. 8C shows the manner where it is deformed into a far point position as a current C_{M13} is caused to flow to the third variable configuration mirror C to bring the focus to a far point (infinity).

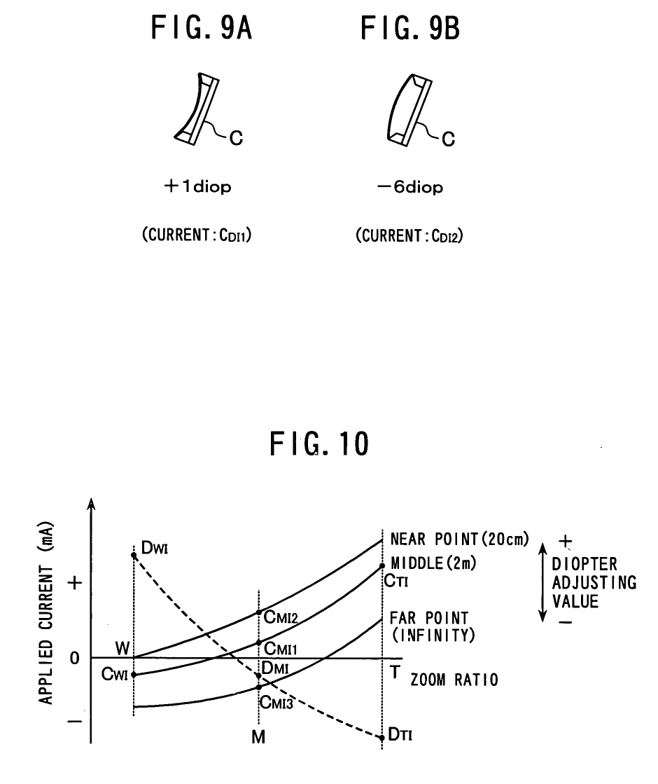

Examples of the configuration of the third variable configuration mirror C (in the case of the electromagnetically driven type) in the diopter adjustment at the finder optical system are shown in FIGS. 9A and 9B. FIG. 9A shows the manner of its deformation as a current C_{D11} is caused to flow to the third variable configuration mirror C to correct the diopter to +1 diop in a combination with other optical system in the case where the zoom ratio is set to the intermediate value M. FIG. 9B shows the manner of its deformation as a current C_{D12} is caused to flow to the third variable configuration mirror C to correct the diopter to −6 diop.

It should be noted that the configuration of the mirror body of the third variable configuration mirror C at the time without conduction of electricity is to be brought to a standard diopter condition in a combination with other finder optical system so that a finder image, though unclear, can be visually confirmed even when electricity is not being supplied. The configuration of the mirror body of the third variable configuration mirror in the condition without electricity, though flat in most cases, can also be previously processed and formed into a non-flat configuration. A standard diopter is the diopter of an average photographer and for example is on the order of −1 diop to −4 diop.

Shown in FIG. 10 are characteristic curves of the currents to be respectively applied to the third and fourth variable configuration mirrors C, D and a diopter adjusting value range in adjusting the zoom ratio and adjusting focus in the above described finder optical system 16. In FIG. 10, the solid lines indicate current curves applied to the third variable configuration mirror C and dotted line indicates a current curve applied to the fourth variable configuration mirror D. Each current value (current data) of these application current characteristic curves is stored to the flash memory 23 in the manner of a look-up table similarly to the voltage values to be applied to the first and second variable configuration mirrors A, B of the taking optical system 3. Further, concerning the diopter adjustment, since 5 to 6 points or so suffice as the actual adjusting points, the current correcting data to be used for such diopter adjustment is stored in the form of a separate look-up table as the correcting values for correcting current data in the above described zoom ratio adjustment and focus adjustment.

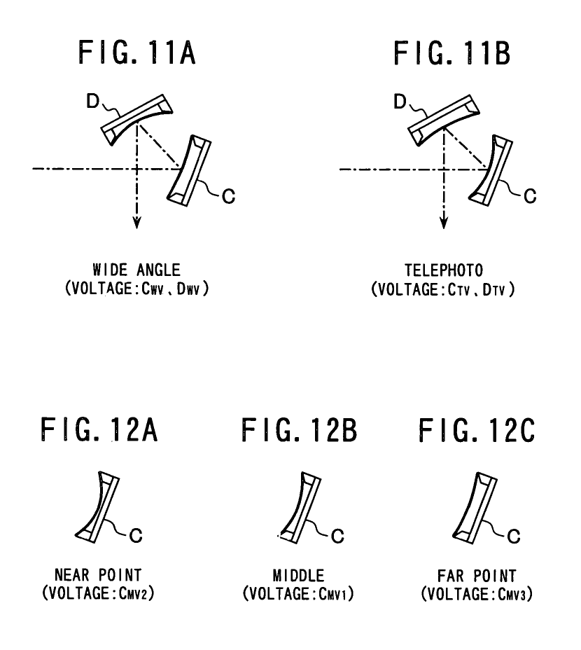

A description will now be given with respect to examples of change in configuration at the two ends of zoom ratios in adjusting the zoom ratio when those of the electrostatic type are used as the third and fourth variable configuration mirrors C, D of the finder optical system 16. FIG. 11A shows the manner of the mirror body deformed into a wide-angle position as wide zoom voltages C_{WV}, D_{WV} are applied respectively to the third and fourth variable configuration mirrors C, D to bring the zoom ratio to a wide-angle value W. FIG. 11B shows the manner where it is deformed into a telephoto position as telephoto zoom voltages C_{TV}, D_{TV} are applied respectively to the third and fourth variable configuration mirrors C, D to bring the zoom ratio to a telephoto value T.

Shown in FIGS. 12A to 12C are examples of the change in configuration in adjusting focus from near point to far point of the electrostatic type third variable configuration mirror C in the finder optical system 16. FIG. 12A shows the manner of its deformation to a near point position as a voltage C_{MV2} is applied to the third variable configuration mirror C to bring the focus to a near point (20 cm) in the case where the zoom ratio is set to the intermediate value M. FIG. 12B shows the manner where it is deformed into an intermediate position as a voltage C_{MV1} is applied to the third variable configuration mirror C to bring the focus to an intermediate distance (2 m). FIG. 12C shows the manner where it is deformed into a far point position as a voltage C_{MV3} is applied to the third variable configuration mirror C to bring the focus to a far point (infinity).

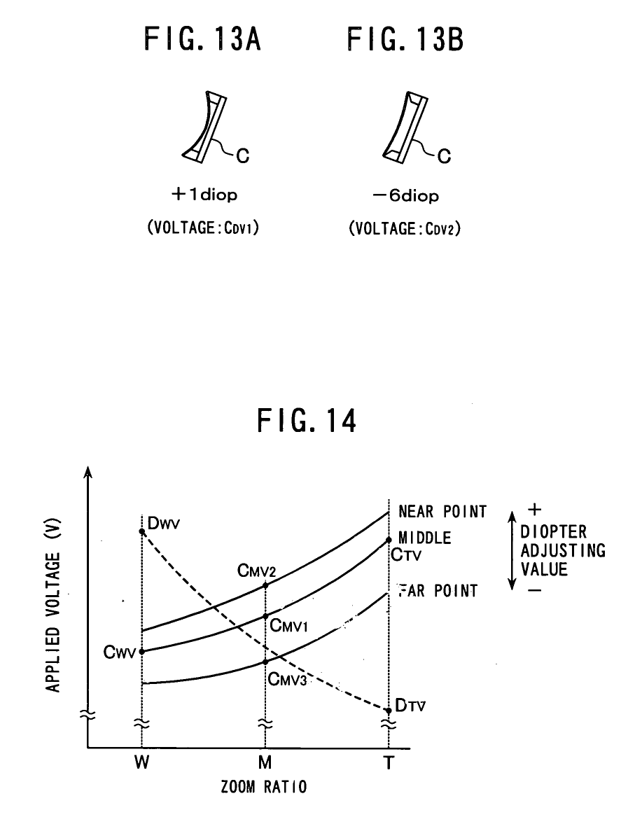

Examples of the configuration of the third variable configuration mirror C (the case of the electrostatic type) in the diopter adjustment at the finder optical system are shown in FIGS. 13A and 13B. FIG. 13A shows the manner of its deformation as a voltage C_{DV1} is applied to the third variable configuration mirror C to correct the diopter to +1 diop in a combination with other optical system in the case where the zoom ratio is set to the intermediate value M. FIG. 13B shows the manner of its deformation as a voltage C_{DV2} is applied to the third variable configuration mirror C to correct the diopter to −6 diop.

Shown in FIG. 14 are characteristic curves of the voltages to be respectively applied to the mirrors C, D and a diopter adjusting value range in adjusting the zoom ratio and adjusting focus in the case where the electrostatic type third and fourth variable configuration mirrors C, D are used in the above described finder optical system 16. In FIG. 14, the solid lines indicate voltage curves applied to the third variable configuration mirror C and dotted line indicates a voltage curve applied to the fourth variable configuration mirror D. Each voltage value (voltage data) of these application voltage characteristic curves is stored to the flash memory 23 in the manner of a look-up table similarly to the voltage values to be applied to the first and second variable configuration mirrors A, B of the taking optical system. Further, concerning the diopter adjustment, the voltage correcting data to be used for such diopter adjustment is stored in the form of a separate look-up table as the correcting values for correcting voltage data in adjusting the zoom ratio and adjusting focus similarly to the case of the electromagnetically driven type.

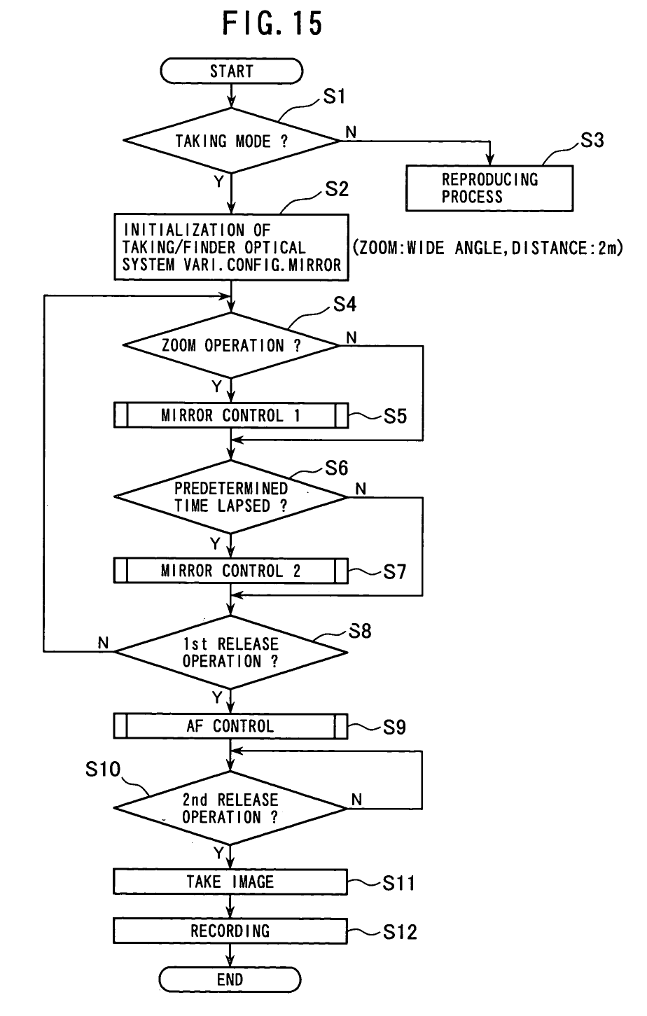

The operation of the digital camera as a whole including the image taking section 1 and finder section 11 will now be described. First a description will be given by way of the flowchart shown in FIG. 15 with respect to the zoom adjustment and AF control up to the recording operation. The flowchart of FIG. 15 shows a main routine. Since the optical system 3 of the image taking section 1 and the optical system 16 of the finder section 11 are not used when the operation mode of the digital camera is a reproducing mode which is not a taking mode, it is first decided upon the turning ON of power whether the operation mode is a taking mode or not (step S1). If the operation mode is a taking mode, the first to fourth variable configuration mirrors A to D used in the taking optical system 3 and finder optical system 16 are initialized (step S2). If the operation mode is not a taking mode, a reproduction processing is executed (step S3).

In the initialization of the taking optical system 3 and finder optical system 16, since a wider expanse of field as possible is usually initially desirable in the digital camera having a zoom function, the zoom is brought to a wide angle and the object distance (focus) is at first automatically set to 2 m which is a middle value (default value). Each of the first to fourth variable configuration mirrors A to D of the taking optical system and the finder optical system is accordingly controlled with respect to the conduction of electricity.

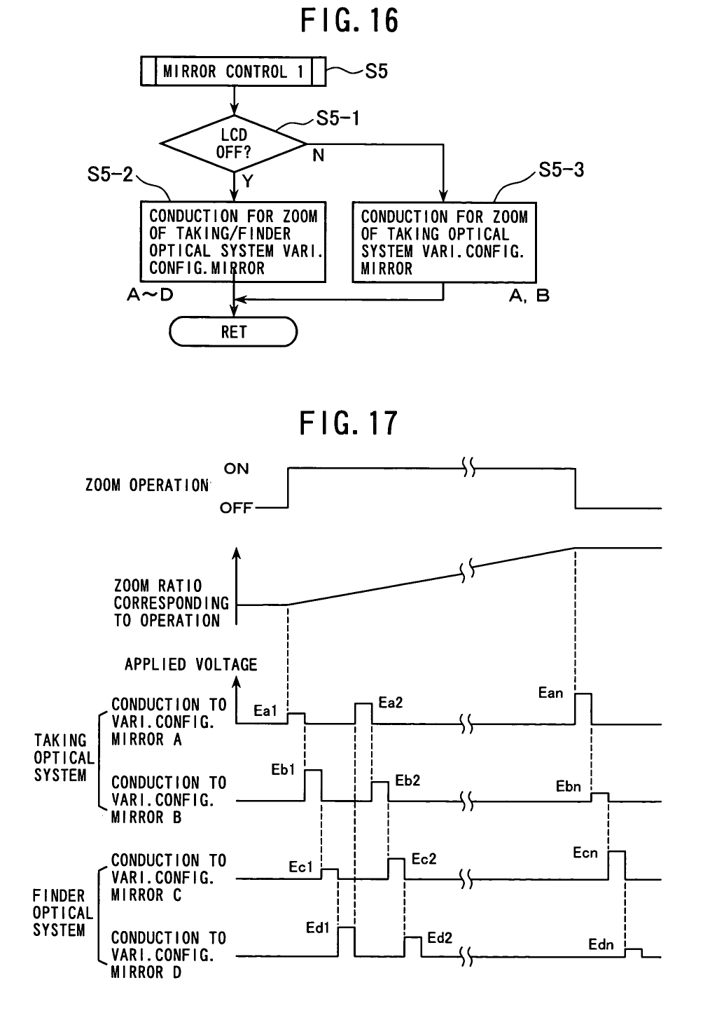

Subsequently to the initialization of the respective variable configuration mirrors of the taking optical system 3 and finder optical system 16, a decision is made as to whether a zoom operation is to be effected or not (step S4). If the zoom operation is to be effected, the step enters a subroutine operation of First Mirror Control 1 (step S5). As shown in the flowchart of FIG. 16, if an image is displayed at LCD of the image display section 28 in the subroutine operation of First Mirror Control 1, it is assumed that the image to be taken is being confirmed by such displayed image and thus use of the optical finder is unnecessary. For this reason, a decision is first made as to whether LCD of the image display section 28 is OFF or not (step S5-1).

If LCD of the image display section 28 is OFF at such decision step, electricity for the zoom adjustment corresponding to a set zoom ratio is conducted to the taking optical system variable configuration mirrors A, B and to the finder optical system variable configuration mirrors C, D (step S5-2). If on the other hand LCD of the image display section 28 is ON, the conduction of electricity for zoom operation is effected only to the taking optical system variable configuration mirrors A, B, since it is not necessary to cause an operation of the finder optical system variable configuration mirrors C, D (step S5-3). The subroutine operation of First Mirror Control 1 is terminated by these operations and the step returns to the main routine again.

In adjusting zoom as the above, if those of the electrostatic type are used as both the taking optical system variable configuration mirrors A, B and the finder optical system variable configuration mirrors C, D, the conduction of electricity to the respective variable configuration mirrors A to D is effected as follows. In particular, as shown in the timing chart of FIG. 17, when a zoom operation by a zoom lever or zoom button has been effected, the conduction of electricity (voltage application) for the respective variable configuration mirrors to be used in the taking optical system 3 and finder optical system 16 is effected in accordance with a zoom ratio corresponding to the extent of such operation.

At this time, the conduction of electricity is effected in a sequentially shifted manner to each of the variable configuration mirrors A to D so as not to cause an overlap of one electricity conduction time (timing) with another. The amount of the conduction of electricity is then sequentially increased in accordance with the respective zoom ratios from wide-angle toward telephoto as indicated by the electricity conduction amounts for the respective variable configuration mirrors A to D from Ea1, Eb1, Ec1, Ed1 to Ea2, Eb2, Ec2, Ed2 so that a final configuration corresponding to a set zoom ratio is obtained by the electricity conduction amounts Ean, Ebn, Ecn, Edn. By thus controlling the conduction of electricity (voltage application) to each variable configuration mirror in adjusting zoom, an increase in peak current can be prevented.

It should be noted that the above described divisional drive method for shifting the electricity conduction time to each variable configuration mirror is to be effected only when the variable configuration mirrors of the electrostatic type are used. Accordingly, when those of the electromagnetically driven type are used as the variable configuration mirrors A to D to be used for the taking optical system 3 and finder optical system 16, currents corresponding to the zoom ratio set for example by a zoom lever are continuously applied concurrently to the variable configuration mirrors A to D until the termination of an image taking operation after going through a subsequent AF control.

Referring again to the flowchart of the main routine shown in FIG. 15, the subsequent operation will be described below. Subsequent to the termination of the operation of the subroutine step S5 of First Mirror Control 1, if those of the electrostatic type are used as the variable configuration mirrors, it is then decided whether or not a predetermined time has elapsed since the termination of conduction of electricity for zoom operation in the subroutine operation of First Mirror Control 1 (step S6). If zoom operation is not effected at the above described step S4 for deciding whether zoom operation is to be effected or not, the operation step S5 of First Mirror Control 1, which is a subroutine step, is omitted. Also in such a case, the above decision on the passage of the predetermined time is effected. In other words, it is decided whether or not the predetermined time has elapsed after the conduction of electricity for the initialization of the variable configuration mirrors to be used for the taking optical system 3 and finder optical system 16.

The reason for making a decision on the passage of the predetermined time is as follows. In particular, while the application of voltage in the case of an electrostatic type variable configuration mirror is stopped to save power after applying the voltage for changing its configuration into a predetermined configuration, a leakage of electric charge occurs as time elapses after the stopping of such voltage application and it becomes impossible to retain the predetermined changed configuration of the mirror body. In order to retain the predetermined changed configuration within a range of permissible values, it is necessary to repeat the voltage application at predetermined time intervals.

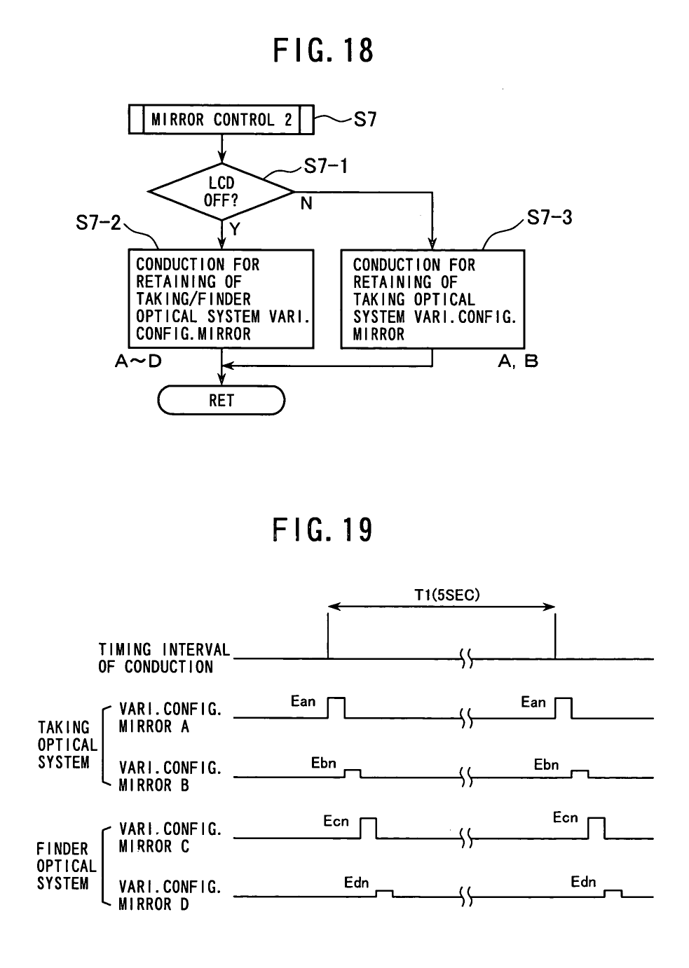

If the predetermined time (5 seconds in this case) has elapsed after an interruption of the conduction of electricity at the above described step S6 for deciding the passage of the predetermined time, the step enters a subroutine operation of Second Mirror Control 2 (step S7). As shown in the flowchart of FIG. 18, in the subroutine of Second Mirror Control 2, it is first decided whether LCD of the image display section 28 is OFF or not (step S7-1) similarly to the operation of the subroutine of First Mirror Control 1. If LCD of the image display section 28 is OFF at the decision step S7-1, the conduction of electricity for retaining mirror is effected for the taking optical system variable configuration mirrors A, B and at the same time for the finder optical system variable configuration mirrors C, D (step S7-2). If on the other hand LCD of the image display section 28 is ON, the conduction of electricity for retaining mirror is effected only for the taking optical system variable configuration mirrors A, B, since the finder optical system variable configuration mirrors C, D are not caused to operate (step S7-3). The subroutine operation of Second Mirror Control 2 is terminated by these operations and the step returns to the flow of the main routine again.

The conduction of electricity (voltage application) for retaining the configuration of the electrostatic type variable configuration mirrors A to D is effected as follows. In particular, as shown in FIG. 19, voltages Ean, Ebn, Ecn, Edn for the final changed configuration are applied to the respective variable configuration mirrors A to D in a sequentially shifted manner so as not to cause an overlap of the electricity conduction time for the respective variable configuration mirrors A to D, and the voltage application to the variable configuration mirrors A to D in this manner is repeated at a predetermined electricity conduction timing interval T1 (5 sec in this example). It is thereby possible to prevent an increase in peak current even at the time of conducting electricity for the retention.

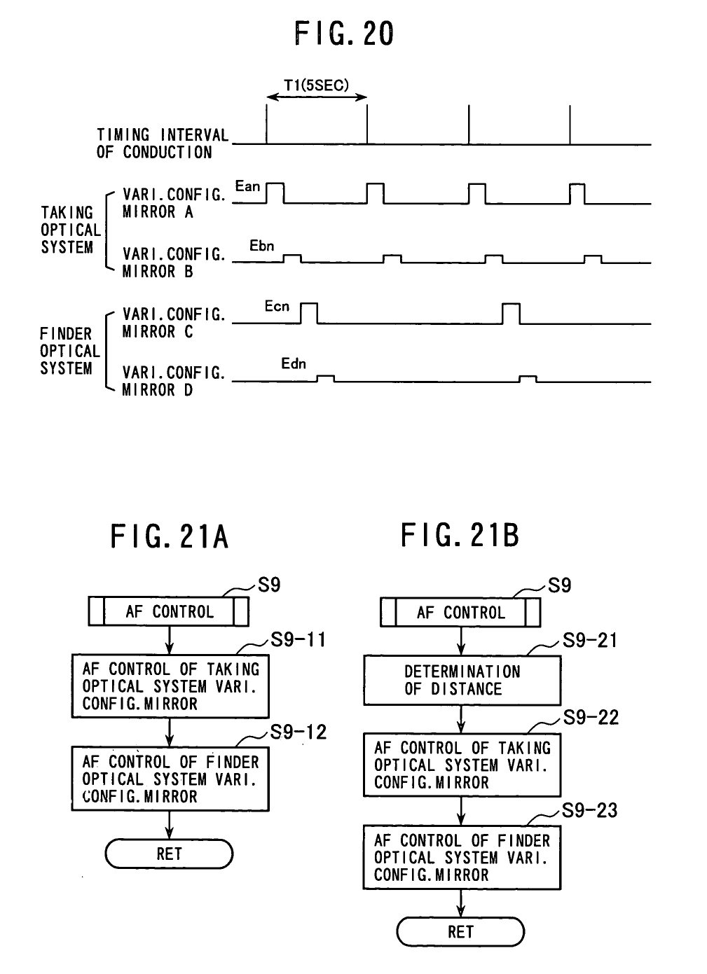

Further, the retaining of the variable configuration mirrors C, D to be used for the finder optical system 16 to a predetermined changed configuration is less important than the retaining of a predetermined changed configuration of the taking optical system variable configuration mirrors A, B, and its permissible range can presumably be made wider than that of the taking optical system variable configuration mirrors. Accordingly, as shown in FIG. 20, it is also possible for example to make the electricity conduction timing interval (the frequency of conducting electricity) for the finder optical system variable configuration mirrors C, D twice as long (10 sec in this example) as the electricity conduction timing interval for the taking optical system variable configuration mirrors A, B. It is thereby possible to achieve a further reduction in power consumption.

It should be noted that the above described step S6 for deciding the passage of predetermined time and the subroutine operation step S7 of Second Mirror Control 2 are to be effected only when those of the electrostatic type are used as the variable configuration mirrors A to D for the taking optical system 3 and for the finder optical system 16. Accordingly, if those of the electromagnetically driven type are used as the variable configuration mirrors A to D, the predetermined time passage deciding step S6 and Second Mirror Control 2 subroutine operation step S7 are omitted.

Referring again to the flowchart of the main routine shown in FIG. 15, the subsequent operations will be described below. After the effecting of the operation of the subroutine step S7 of Second Mirror Control 2, it is decided whether a manipulation of 1st release has been performed or not (step S8). Also in the case where the predetermined time has not elapsed at the predetermined time passage deciding step S6, the step jumps the subroutine step S7 of Second Mirror Control 2 and proceeds to the above described step S8 for deciding 1st release manipulation. It should be noted that the step proceeds to the 1st release manipulation deciding step S8 also when those of the electromagnetically driven type are used as the variable configuration mirrors A to D so that the predetermined time passage deciding step S6 and Second Mirror Control 2 subroutine step S7 are omitted.

Upon the rendering of such 1st release manipulation, it is regarded as a beginning of the image taking/preparation of the camera and a subroutine operation of AF control is started (step S9). It should be noted that, if 1st release manipulation is not performed, the step returns to step S4 and the operation of step S4 through step S8 is repeated until the 1st release manipulation is performed.

Among AF control are hill climbing AF (contrast detection AF) methods and range finding AF methods. If AF control by the hill climbing method (contrast detection method) is used, since only the taking optical system is required to be directly controlled in the AF control as shown in FIG. 21A, AF control by the taking optical system variable configuration mirror A is effected (step S9-11). Accordingly, the conduction of electricity for the finder optical system variable configuration mirrors is not effected during the period of AF control by the hill climbing method (contrast detection method), i.e., during the detection of focus. In AF control by the hill climbing method (contrast detection method), the configuration of the taking optical system variable configuration mirror is changed from its infinity position toward close range so that the object distance is gradually changed (using application voltage corresponding to the application voltage curve shown in FIG. 6). The contrast values of the images taken at the respective object distances are then stored and one object distance of which the contrast is at a peak value is judged as the focused position. The taking optical system variable configuration mirror A is brought to a configuration at which it is focused to the object distance. A voltage or current corresponding to the object distance judged as focused by AF control of the hill climbing (contrast detection) method (voltage or current corresponding to the voltage curve or current curve shown in FIG. 14 or FIG. 10) is then applied to the finder optical system variable configuration mirror C to effect AF control of the finder optical system variable configuration mirror C (step S9-12).

If on the other hand AF control by the range finding method is used, the object distance is detected as shown in FIG. 21B by an output of a range finding sensor (not shown) provided in the imaging apparatus (digital camera) (step S9-21). A voltage for the detected object distance is applied to the taking optical system variable configuration mirror A to effect AF control (step S9-22). A voltage or current also corresponding to the detected object distance is then applied to the finder optical system variable configuration mirror C to effect AF control thereof (step S9-23). It should be noted that the variable configuration mirror to be subjected to AF control corresponding to the detected object distance at first may either be that to be sued for the taking optical system or that to be used for the finder optical system.

If a through image is displayed by LCD of the image display section 28, since it is not necessary also in the above AF control to use the optical finder section, AF control operation of the finder optical system variable configuration mirror is not to be effected. Further, in the above AF control, a correction of shift in focal point resulting from zoom adjustment can be additionally effected by AF control of the finder optical system variable configuration mirror C.

Upon the termination of the above AF control operation, the step returns again to the main routine to decide whether 2nd release manipulation has been rendered or not (step S10). If such 2nd release manipulation has not been rendered, the step waits until the rendering of such manipulation. When the 2nd release manipulation has been rendered, an image taking operation is effected (step S11), and taken image is recorded (step S12).

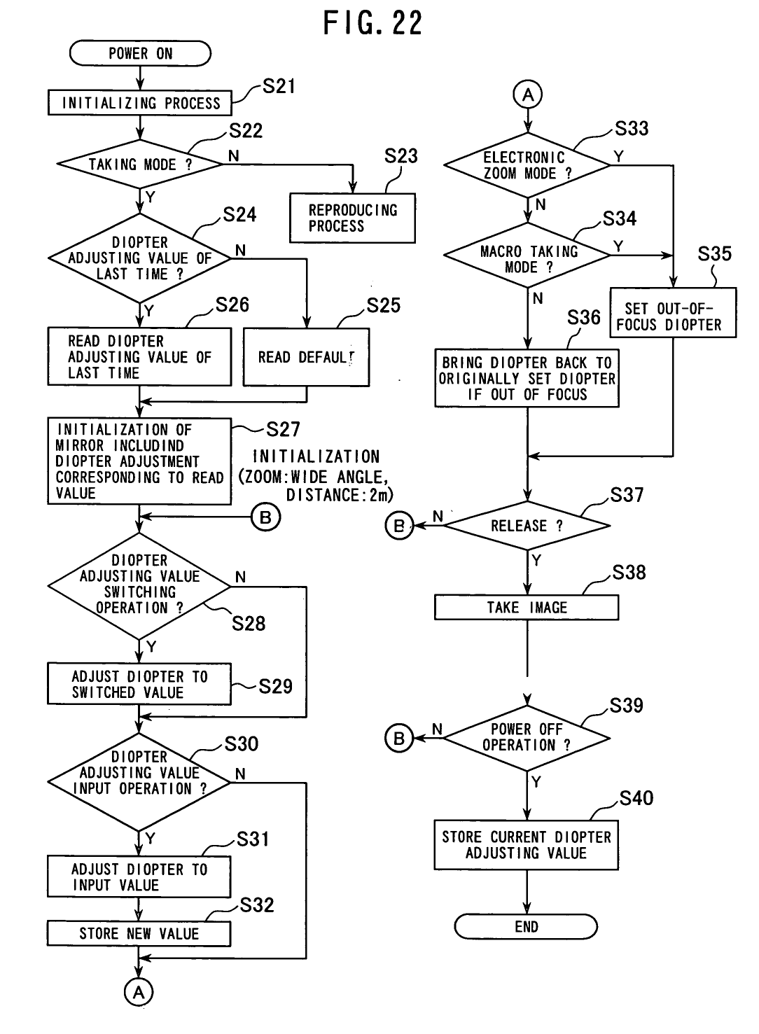

A description will now be given by way of the flowchart of FIG. 22 with respect to the diopter adjusting operation which is effected in parallel to the zoom adjustment and AF control shown in FIG. 15. In the diopter adjustment, upon the turning ON of the power supply, though an explanation has been omitted in the operation of zoom adjustment and AF control previously shown in FIG. 15, the normal operating condition of each section such as CPU is checks and an initial processing for initializing each section is effects (step S21). In the case of a reproducing mode which is not an image taking mode, since a diopter adjustment is not necessary, a decision is then made similarly to the case of zoom adjustment as to whether the operation mode is an image taking mode or not (step S22). If not in an image taking mode, the step proceeds to a reproduction processing operation (step S23).

If the operation mode is an image taking mode, since the diopter adjusting value is unique to each photographer, it is decided whether or not there is a diopter adjusting value of the last time (step S24). Since the case where there is no diopter adjusting value of the last occasion of the camera's operation presumably occurs only at the time of shipment from factory, a default value (for example −1 diop) is read out in such a case as indicated at No.1 of Table 1 which is stored as a look-up table (step S25). In the case where there is a diopter adjusting value of the last time, the diopter adjusting value (for example +1 diop) of the last time is read out from No.2 of Table 1 which is also stored as a look-up table (step S26). An initialization of the variable configuration mirror C including the diopter adjustment corresponding to the read diopter adjusting value is then effected (step S27). The zoom at this initialization is set to a wide angle and the object distance is set to 2m.

TABLE 1

| | stored diopter |
|---|---|
| | adjusting value (diop) |
| No. 1 (default) | −1 |
| No. 2 (last time) | +1 |
| No. 3 (existing value) | −3 |
| No. 4 (new) | −1 |

A decision is then made as to whether or not an operation is effected for switching the diopter adjusting value read out at the time of initialization to another stored diopter adjusting value (an existing value designated by the user) (step S28). If such switching operation is to be effected, the diopter is adjusted to a predetermined switching value (for example −3 diop) indicated at No.3 of Table 1 (step S29). It is thereby possible to readily set to a previously registered, one's own diopter adjusting value even when the camera is shared by a plurality of persons. It is then decided whether an input operation of new diopter adjusting value is to be effected or not (step S30). Even when the switching operation of the diopter adjusting value is not effected at the diopter adjusting value switching operation deciding step S28, the deciding operation at the input operation deciding step S30 is effected. When an input operation of such new diopter adjusting value is to be effected, a new input value is inputted from the operation section to effect a diopter adjustment (step S31), and the new diopter adjusting value (for example −1 diop) is stored to No.4 of Table 1 (step S32) It should be noted that, if neither a switching operation nor new inputting operation of the diopter adjusting value is to be effected, the setting at the initialization is unchanged.

The step is then continued from the flowchart on the left side to the flowchart on the right side in FIG. 22. Since the using of an optical finder is unsuitable in the case where an electronic zoom is used in an image taking mode or in the case of a macro image taking where the effect of parallax is large, it is decided whether the image taking mode is of an electronic zoom mode or not (step S33). If not of an electronic zoom mode, a decision is then made as to whether it is of a macro taking mode or not (step S34). In the case of the electronic zoom mode or in the case of the macro taking mode, the diopter is set to an extremely deviated, abnormal condition to intentionally provide an indistinct condition so as to give a warning that the use of an optical finder is unsuitable (step S35). As the abnormal diopter condition in this case, it is set for example to 4 diop or so (an extremely farsighted condition), increase of 5 diop from the standard diopter of −1 diop, or to −10 diop or so (an extremely nearsighted condition). It should be noted that the above described macro taking mode deciding step S34 may be replaced by a step for deciding by a range finder means whether the distance is short (for example within 1 m) or not.

Those cases not in the electronic zoom mode and not in the macro taking mode at the electronic zoom mode deciding step S33 and the macro taking mode deciding step S34 include the case where these modes have been canceled after going through the abnormal diopter setting step S35. Since it is necessary in such a case to bring the diopter value to the original condition, an operation for restoring the originally set diopter adjusting value is effected if the diopter is in the extremely deviated, abnormal condition (step S36).

It is then decided whether a release manipulation has been rendered or not (step S37). If a release operation is not effected, the step returns to step S28 and the operation of step S28 through step S36 is repeated until the rendering of a release manipulation. Upon the rendering of release manipulation, an image taking is effected (step S38). It is then decided whether power OFF operation has been effected or not (step S39). If the power OFF operation is not effected, the step returns to step S28 and step S28 through step S38 are repeated until the effecting of the power OFF operation. Upon the effecting of power OFF operation, the current (last) diopter adjusting value is stored to No.2 of Table 1, and the diopter adjusting operation is terminated (step S40).

Since the diopter adjusting value of the last time when power is turned OFF is stored in this manner, the diopter of the finder upon the turning ON of power again at the next time is set to the stored last diopter adjusting value and its immediate use is possible. Further, while the above Table 1 has been shown as that storing only a single diopter adjusting value as the existing value, it is also possible to store diopter adjusting values for a plurality of photographers as the existing value whereby making it possible to correspond to the diopter adjustments of the plurality of photographers.

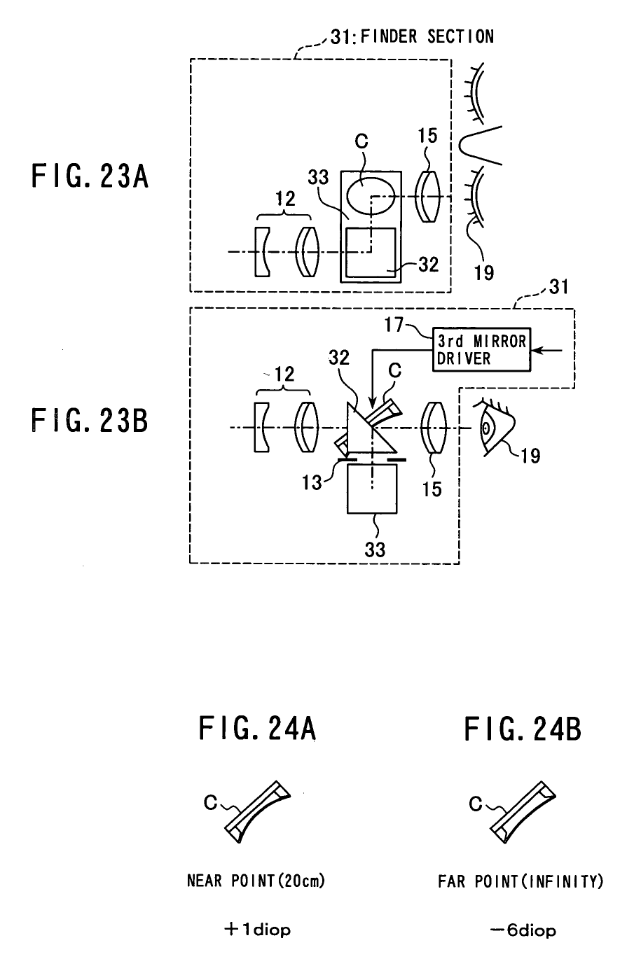

A second embodiment will now be described. In this embodiment, as shown in FIGS. 23A and 23B, a finder section 31 is constructed by using a single variable configuration mirror instead of using two variable configuration mirrors. The construction of the other portions thereof is substantially identical to the first embodiment shown in FIG. 3. FIG. 23A is a front view of the finder section 31, and FIG. 23B is a side view thereof where like or corresponding members as in the first embodiment shown in FIG. 3 are denoted by like reference numerals.

The finder section 31 of this embodiment includes: an objective lens 12; a first prism 32; a field stop 13; a second prism 33; a variable configuration mirror C, an eyepiece 15; and a mirror driver 17 controlled by CPU, for driving the variable configuration mirror C. An incident light through the objective lens 12 is incident on the first prism 32 and is reflected downward. The reflected light thereof is further incident on the second prism 33 through the field stop 13 and is reflected therefrom. The reflected light is incident on the variable configuration mirror C and the reflected light therefrom is incident on the pupil 19 of the photographer through the eyepiece 15.

In this embodiment, a zoom operation cannot be effected due to the fact that only one unit of the variable configuration mirror C is used, but focus adjustment (correction of focal point) and diopter adjustment can be effected by an adjustment of changed configuration of the variable configuration mirror C. The focus adjustment is effected by configuration adjustment of the mirror body based on an adjustment of current (electromagnetically driven type) or voltage (electrostatic type) to be applied to the variable configuration mirror C as shown in FIGS. 8A to 8C or FIGS. 12A to 12C. Further, the diopter adjustment is effected also by configuration adjustment based on an adjustment of current or voltage to be applied to the variable configuration mirror C similarly to the focus adjustment. FIGS. 24A and 24B show the correspondence between the focus adjusting values and the diopter adjusting values corresponding to changed configurations of the variable configuration mirror C in the case where an electrostatic type variable configuration mirror is used. FIG. 24A indicates that the manner of bringing focus to a near point position (20 cm) corresponds to a diopter of +1 diop when combined with other optical system; and FIG. 24B indicates that the manner of bringing focus to a far point position (infinity) corresponds to a diopter of −6 diop.

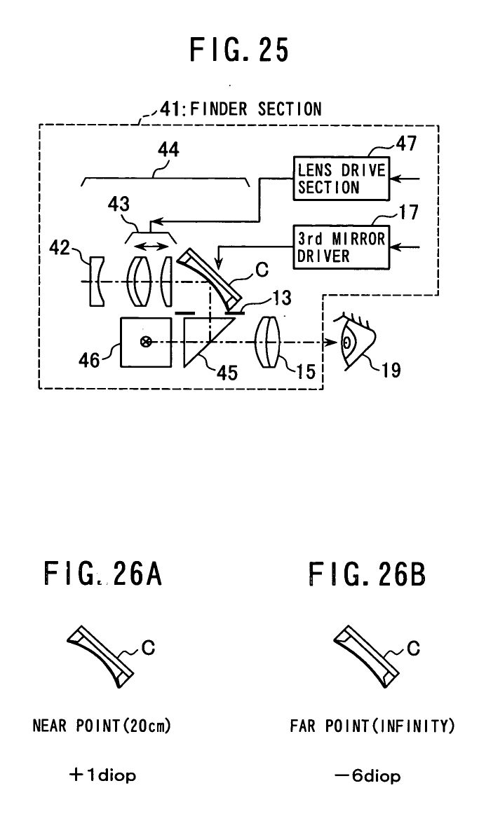

A third embodiment of the invention will now be described by way of FIG. 25. In this embodiment, a finder section 41 is constructed so that a zoom operation can also be effected by using a single variable configuration mirror. The construction of the other portions thereof is substantially identical to that shown in FIG. 3. FIG. 25 is a side view of the finder section 41 where like or corresponding members as in the first embodiment shown in FIG. 3 are denoted by like reference numerals.

The finder section 41 of this embodiment includes: an objective lens group 44 consisting of an entrance concave lens 42, a moving lens group 43, and a variable configuration mirror C; a field stop 13; a third prism 45: a fourth prism 46; an eyepiece 15; a lens drive section 47 controlled by CPU, for driving the moving lens group 43; and a mirror driver 17 controlled by CPU, for driving the variable configuration mirror C. An incident light through the entrance concave lens 42 passes through the moving lens group 43 and is incident on the variable configuration mirror C. A reflected light therefrom passes through the third prism 45 and fourth prism 46 by way of the stop 13 and furthermore passes through the eyepiece 15 to be incident on the pupil 19 of the photographer.

In this embodiment, a zoom ratio adjustment is effected by the moving lens group 43, while adjusting of focus, correction of focal point due to the zoom adjustment and adjusting of diopter can be effected by the variable configuration mirror C. The focus adjustment by the variable configuration mirror C or focal point correction thereof resulting from zoom adjustment is effected by configuration adjustment of the mirror body based on an adjustment of current (electromagnetically driven type) or voltage (electrostatic type) to be applied to the variable configuration mirror C as shown in FIGS. 8A to 8C or FIGS. 12A to 12C. Further, the diopter adjustment is also effected by configuration adjustment based on an adjustment of current or voltage to be applied to the variable configuration mirror C similarly to the focusing.

FIGS. 26A and 26B show the correspondence between the focus adjusting values and the diopter adjusting values corresponding to changed configurations of the variable configuration mirror C in the case where an electrostatic type variable configuration mirror C is used. FIG. 26A indicates that the manner of bringing focus to a near point position (20 cm) corresponds to a diopter of +1 diop when combined with other optical system; and FIG. 26B indicates that the manner of bringing focus to a far point position (infinity) corresponds to a diopter of −6 diop.

Similarly to the first embodiment, it is possible also in the above described third embodiment to employ the divisional drive for shifting the time of voltage application to each variable configuration mirror from that to another and the intermittent drive method in retaining changed configuration in the case where those of the electrostatic type are used as the variable configuration mirrors A, B of the taking optical system.

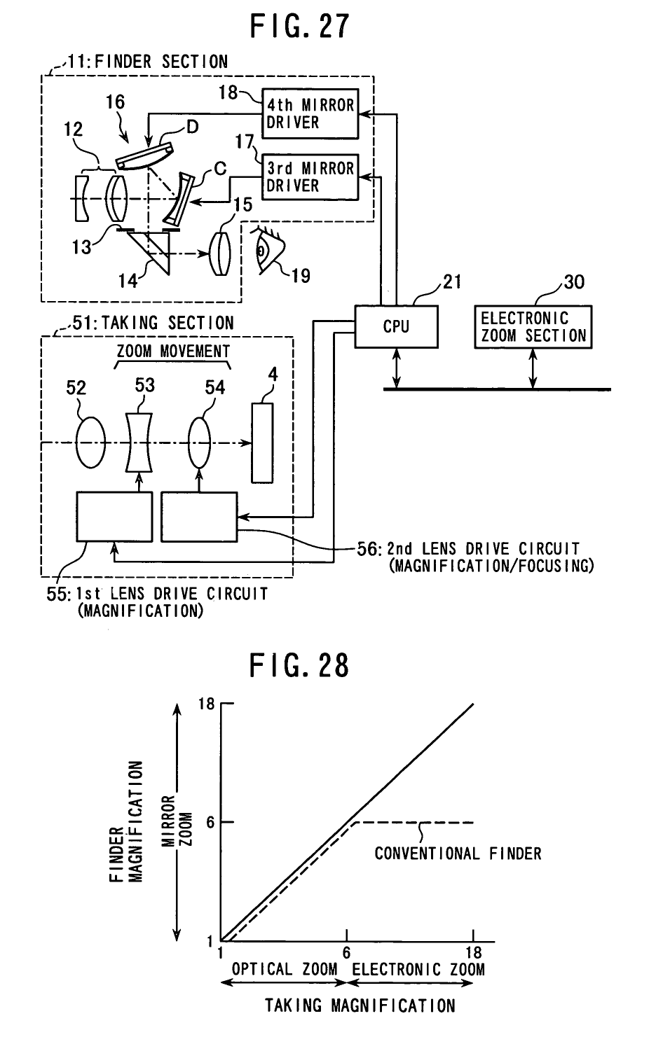

A fourth embodiment of the invention will now be described. FIG. 27 is a block diagram showing the fourth embodiment. This embodiment is characterized in that an electronic zoom processing can be effected and that the optical system of the image taking section is constructed only by lenses. The construction of the other portions thereof including the image processing system and operation control system is similar to the first embodiment. Those portions of the image processing system and operation control system provided in common with the first embodiment except CPU are not shown in the figure.

An image taking section 51 of this embodiment includes: an entrance convex lens 52; a zoom (variable power) concave lens 53; a zoom and focus convex lens 54; an imaging device 4; a first lens drive circuit 55 for driving the zoom lens 53 to be used in varying magnification; and a second lens drive circuit 56 for driving the zoom/focus lens 54 to be used in varying magnification and bringing to focus. The construction of a finder section 11 is similar to that of the first embodiment and a description thereof will be omitted. An electronic zoom section 30 for effecting an electronic zoom processing based on image processing is additionally provided in the image processing system.

The operation of the fourth embodiment having such construction will now be described. First, a general operation of the image taking section 51 will be described below. At the time of zoom ratio adjustment in a low image taking magnification range to be described later, the moving of the zoom lens 53 and zoom/focus lens 54 is adjusted along the optical axis by the first and second lens drive circuit 55, 56 by way of CPU 21 in accordance with the zoom ratio which has been inputted and instructed from the operation section. Further, at the time of focus adjustment, the moving of the zoom/focus lens 54 is adjusted along the optical axis by the second lens drive circuit 56 by way of CPU 21 based on AF signals from the AF circuit.

A description will now be given with respect to the zoom ratio adjustment of this embodiment as a whole including the finder section 11. Of the image taking magnification adjustment (zoom ratio adjustment) of the image to be taken in this embodiment, the zoom adjustment in the low taking magnification (low zoom ratio) range as described above is effected by an optical zoom based on an adjustment of zoom movement of the taking optical system (zoom lens 53 and zoom/focus lens 54) of the image taking section 51. Furthermore, the zoom adjustment in a high taking magnification (high zoom ratio) range is effected by the electronic zoom processing based on image processing at the electronic zoom section 50.

At the finder section 11, on the other hand, the finder magnification adjustment (zoom ratio adjustment) is effected similarly to the first embodiment by configuration change of the third and fourth variable configuration mirrors C, D based on a current or voltage adjustment from the third and fourth mirror drivers 17, 0.18 which are controlled through CPU 21 by an instruction inputted from the operation section. At this time, the finder magnification (zoom ratio) is adjusted so that it is brought to the same magnification as the taking magnification combining the optical zoom and electronic zoom of the taking system. Further, it is controlled correspondingly to the zoom ratio adjustment of the taking system so that the maximum power of the finder magnification becomes equal to the maximum power of the taking magnification. It is thereby possible to achieve a further enlargement of the taken image based on the electronic zoom processing and, even at the time of electronic zoom processing, to visually confirm at the finder section an image of which the angle of view matches the image to be taken.

FIG. 28 shows the characteristic of the corresponding relation (1:1 correspondence) between the taking magnification and the finder magnification in the fourth embodiment where the horizontal axis-represents the taking magnification and the vertical axis represents the finder magnification. It should be noted that the taking magnification (zoom ratio) here refers to the ratio of a taking focal length to the minimum focal length (wide angle) which is set as the base, and the finder magnification refers to the ratio obtained by setting the size of the finder's visually confirmed image at a reference point of the taking magnification as the base. In this example, as can be seen from FIG. 28, in the low magnification range where the taking magnification (zoom ratio) of the taken image is 1 through 6, the zoom ratio adjustment is effected by an optical zoom based on the taking optical system. In the high magnification range where the taking magnification is 6 through 18, a zoom processing is effected by combining the electronic zoom based on image processing at the electronic zoom section 30 into the optical zoom.

At the finder section, on the other hand, the magnification adjustment is effected by mirror zoom based on change in configuration of the variable configuration mirrors C, D for the entire magnification range where the finder magnification is 1 through 18. In the conventional style where the moving lenses of a taking optical system and a finder optical system are moved in connection with each other, the magnification of the finder optical system cannot correspond to the electronic zoom of the taking system. The dotted line in FIG. 28 indicates a magnification characteristic of the conventional finder which is constructed only by lenses. Since the zoom lens of the finder is designed to move in connection with the lens movement of the taking optical system, it cannot correspond to the electronic zoom of the image taking system.

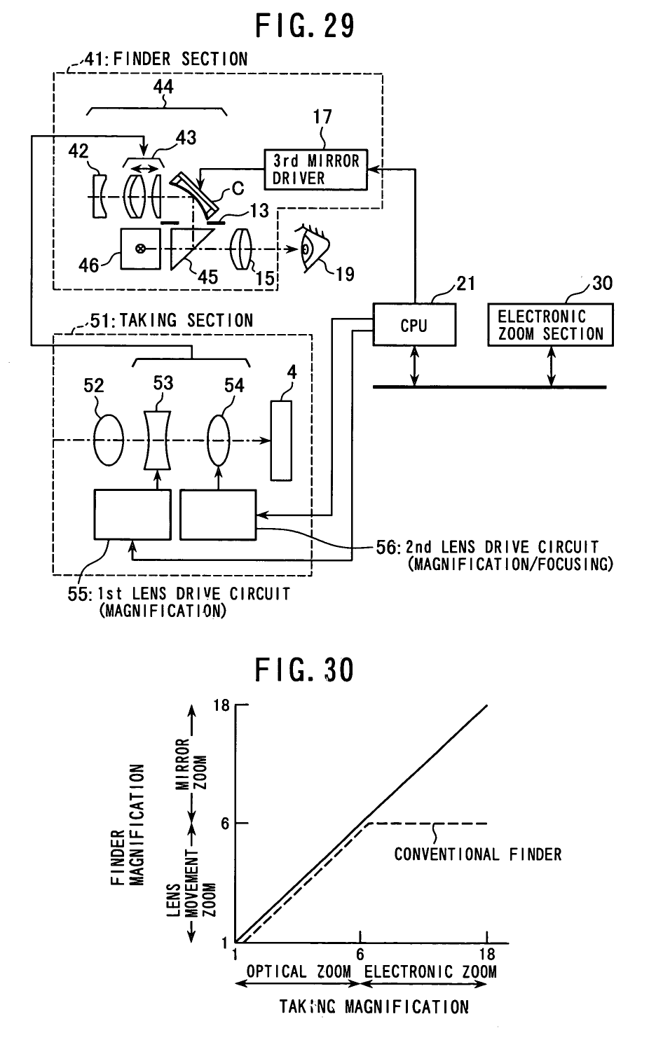

A fifth embodiment of the invention will now be described by way of the block diagram of FIG. 29. In this embodiment, the construction of the finder section in the fourth embodiment shown in FIG. 27 is modified to one similar to the finder section shown in the third embodiment. The construction of the other portions is similar to the fourth embodiment and some portions of the image processing system and operation control system are not shown in the figure similarly to the fourth embodiment shown in FIG. 27.

A finder section 41 of this embodiment is constructed so that zoom adjustment is effected by using a single variable configuration mirror and a moving lens group. It includes: an objective lens group 44 consisting of an entrance concave lens 42, a moving lens group 43, and the third variable configuration mirror C; a field stop 13; a third prism 45; a fourth prism 46; an eyepiece 15; and a third mirror driver 17 controlled by CPU, for driving the variable configuration mirror C. Here, the moving mechanism of the moving lens group 43 of the finder section 41 is connected with the moving mechanism of the zoom lens 53 and zoom/focus lens 54 of the image taking section 51. The moving lens group 43 is thereby driven along the optical axis and zoom adjustment thereof is effected in connection with the zoom movement of the zoom lens 53 and zoom/focus lens 54 by zoom motors which are driven by the first and second lens drive circuits 55, 56 in adjusting zoom of the image taking section 51.

In thus constructed finder section 41, the incident light through the entrance concave lens 42 is incident on the variable configuration mirror C through the moving lens group 43. The reflected light therefrom passes through the third prism 45 and fourth prism 46 by way of the stop 13 and furthermore passes through the eyepiece 15 to be incident on the pupil 19 of the photographer. The zoom adjustment for changing the finder magnification at the finder section 41, in a low magnification range, is effected by zoom adjustment of the moving lens group 43 connected with the zoom lens 53 and zoom/focus lens 54 of the taking section 51 so that it matches the taking magnification of the image taking system. In a high magnification range, on the other hand, it is effected by configuration adjustment of the mirror body based on an adjustment of current or voltage to be applied to the variable configuration mirror C. It should be note that, in addition to zoom adjustment, the variable configuration mirror C is designed to be capable also of effecting a focal point correction due to the zoom adjustment and focus adjustment as well as diopter adjustment.

FIG. 30 shows the characteristic of the corresponding relation between the taking magnification and the finder magnification in the fifth embodiment. As can be seen from this figure, as far as the image taking magnification of the taking system is concerned, the zoom ratio adjustment, in the low magnification range where the taking magnification is 1 through 6, is effected by an optical zoom based on the taking optical system and, in the high magnification range where the taking magnification is 6 through 18, a zoom processing combining the electronic zoom into the optical zoom is effected in a similar manner as the fourth embodiment shown in FIG. 28. At the finder section, on the other hand, the magnification adjustment, in the low magnification range where the finder magnification is 1 through 6, is effected at the equal magnification as the image taking magnification of the taking system based on the zoom adjustment of the moving lens group 43 which is connected with the zoom lens 53 and zoom/focus lens 54 of the taking section 51. Further, in the high magnification range where the finder magnification is 6 through 18, the magnification adjustment at equal magnifications is effected so as to make the maximum magnification thereof the same as the maximum magnification of the taking system, by a zoom processing where a mirror zoom based on configuration adjustment of the variable configuration mirror C is combined into the lens moving zoom.

While the optical finder having the conventional lens zoom system has been unable to correspond to the electronic zoom of the image taking system, this embodiment makes it possible to readily correspond even to the electronic zoom by additionally using a variable configuration mirror in the lens zoom system. Since the maximum magnification of the finder section and the maximum magnification at the taking system are then set to the same as each other, the linkage of the variable power control between the two becomes easier.

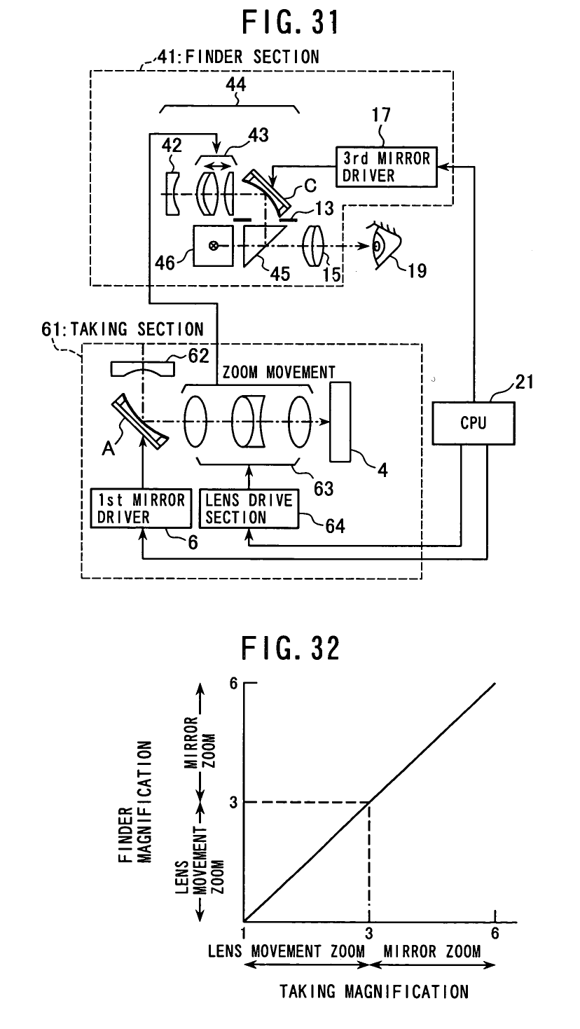

A sixth embodiment of the invention will now be described by way of FIG. 31. In this embodiment, the construction of the image taking section in the fifth embodiment shown in FIG. 29 is modified and the electronic zoom section is removed. The construction of the other portions is similar to the fifth embodiment and such as the image processing system is not shown in the figure.

An image taking section 61 of this embodiment includes: an entrance lens 62; a first variable configuration mirror A; a moving lens group 63; an imaging device 4; a first mirror driver 6 controlled by CPU 21 for driving the first variable configuration mirror A; and a lens drive section 64 controlled by CPU 21 for driving the moving lens group 63. Here the moving mechanism of the moving lens group 43 of the finder section 41 is linked with the moving mechanism of the moving lens group 63 to be driven by the lens drive section 64. Thus the moving lens group 43 of the finder section 41 is moved for zoom operation concurrently together with the moving lens group 63 of the image taking section 61 by a zoom motor to be driven by the lens drive section 64.

The zoom adjustment at the image taking section 61 of the sixth embodiment having such construction, in a low magnification range of the image taking magnification, is effected based on an adjustment of zoom movement of the moving lens group 63 by the lens drive section 64 and, in a high magnification range, is effected by an adjustment of mirror zoom based on configuration adjustment of the first variable configuration mirror A. Further, the first variable configuration mirror A is designed to also effect focus adjustment by AF signals from AF circuit. On the other hand, the adjustment of the finder magnification at the finder section 41, in a low magnification range, is effected similarly to the fifth embodiment as zoom adjustment at equal magnifications as the image taking magnification of the taking system based on movement of the moving lens group 43 which is connected with the moving of the moving lens group 63 of the image taking section 61. In a high magnification range, it is effected by mirror zoom based on configuration adjustment of the third variable configuration mirror C to be driven by the third mirror driver 17.

FIG. 32 shows the characteristic of the corresponding relation between the taking magnification and the finder magnification in the sixth embodiment. As can be seen from this figure, as far as the image taking magnification of the taking system is concerned, the zoom ratio adjustment, in a low magnification range where the taking magnification is 1 through 3, is effected by an optical zoom based on the moving lens group 63 and, in a high magnification range where the taking magnification is 3 through 6, a zoom processing is effected by combining a mirror zoom based on the variable configuration mirror A into the optical zoom based on the moving lens group 63. At the finder section, on the other hand, the magnification adjustment, in the low magnification range where the finder magnification is 1 through 3, is effected at equal magnifications as the image taking magnification of the taking system based on the lens moving zoom adjustment of the moving lens group 43 which is connected with the moving lens group 63 of the image taking section 61. In the high magnification range where the finder magnification is 3 through 6, on the other hand, the finder magnification adjustment at equal magnifications is effected so as to make the maximum magnification thereof the same as the maximum magnification of the taking system, by a zoom processing where a mirror zoom based on configuration adjustment of the variable configuration mirror C is combined into the lens moving zoom similarly to the taking system.

Thus, according to the sixth embodiment, the variable power processing of both the image taking magnification of the taking system and the finder magnification of the finder section, in the low magnification range, is effected by optical zoom based on lens movement, and the variable power processing thereof in the high magnification range is effected by mirror zoom based on configuration adjustment of the variable configuration mirror so that the connected operation in the variable power control of the two can be readily effected.

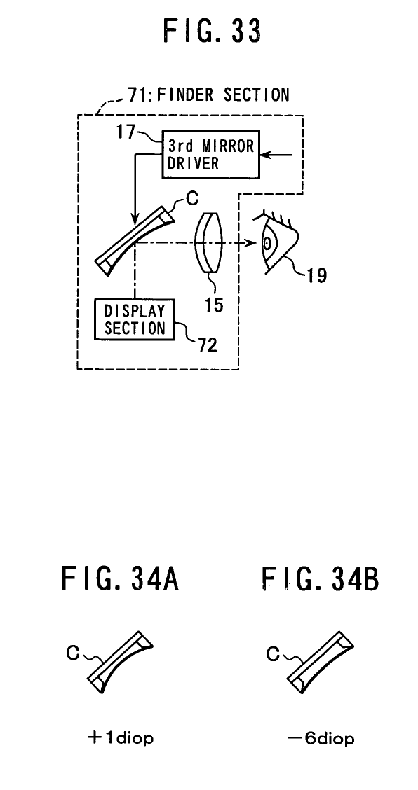

A seventh embodiment of the invention will now be described by way of FIG. 33. In this embodiment, the finder section is constructed by a view finder, and the construction of the other portions thereof is similar to the first embodiment shown in FIG. 3. FIG. 33 is a side view of the finder section where like or corresponding members as in the first embodiment shown in FIG. 3 are denoted by like reference numerals. A finder section 71 of this embodiment includes: a display section 72 for example of LCD for displaying a through image of the object to be taken; a third variable configuration mirror C; an eyepiece 15; and a third mirror driver 17 controlled by CPU for driving the variable configuration mirror C.

In thus constructed finder 71, the through image of an object displayed at the display section 72 is incident on the variable configuration mirror C, and the reflected light therefrom is incident on the pupil 19 of the photographer through the eyepiece 15. The diopter adjustment at the finder 71 is effected by an adjustment of current or voltage to be applied to the variable configuration mirror C by the mirror driver 17 which is controlled by CPU. FIGS. 34A and 34B show the correspondence between the changed configurations of the variable configuration mirror C and the diopter adjusting values in the case where an electrostatic type variable configuration mirror C is used. FIG. 34A shows the configuration of the variable configuration mirror C corresponding to a diopter of +1 diop when it is combined with the eye piece 15, and FIG. 34B shows its configuration corresponding to a diopter of −6 diop.

Lastly, the definition of the terms used in the invention will be described below. An optical apparatus means an apparatus containing an optical system or optical device. The optical apparatus alone is not required to function. In other words, it can be a part of an apparatus. Included in the optical apparatus are: imaging apparatus; observing apparatus: image forming apparatus; and signal processing apparatus.

Examples of the imaging apparatus include: a film camera; digital camera; digital camera for PDA; robot's eye; a lens changing type digital single lens reflex camera; TV camera; dynamic image recording apparatus; electronic dynamic image recording apparatus; cam coder; VTR camera; digital camera of mobile phone; TV camera of mobile phone; and electronic endoscope. A digital camera, card-type digital camera, TV camera, VTR camera, dynamic image recording camera, digital camera of mobile phone, TV camera of mobile phone, and camera of a sound recording apparatus are all an example, of electronic imaging apparatus.

Examples of the observing apparatus include: a microscope; telescope; spectacles; binocular; loupe; fiber scope; finder; and view finder.

Examples of the display apparatus include: a liquid crystal display; view finder; game machine; video projector; liquid crystal projector; head mounted display (HMD); PDA (mobile data terminal); mobile phone.

Examples of the image forming apparatus include the focusing mechanism of the image taking section and finder section of a camera.

Examples of the signal processing apparatus include: a mobile phone; personal computer; game machine; optical disk read/write device; the processing unit of an optical calculator; optical interconnection device; and optical data processing unit.

An imaging device for example refers to: CCD, image pickup tube; solid-state imaging device; camera film, etc. Further, a parallel flat plate is regarded as a type of prism. The change in an observer includes change in one's diopter. The change in an object includes: change in the object distance to be taken; displacement of the object; movement of the object; oscillation; blur caused by the object, etc.

As has been described by way of the above embodiments, it is possible by the invention according to claim 1 to achieve power saving in imaging apparatus, since electricity is conducted only in those cases where the conduction of electricity to the variable configuration mirror is required. By the invention according to claim 2, a further reduction in power consumption at the time of image taking mode can be achieved, since electricity is conducted to the variable configuration mirror in accordance with predetermined instructions such as for zoom and AF in the image taking mode where use of the optical finder is required. By the invention according to claim 3, it possible to achieve power saving at the time of a through image displaying mode, since electricity is not conducted to the variable configuration mirror at the time of the through image displaying mode where the optical finder is not used.

By the invention according to claim 4, an efficient construction is possible of the optical finder having a variable configuration mirror of low power consumption. By the invention according to claim 5, a variable magnification power operation of the optical finder can be effected at low electric power consumption. By the invention according to claim 6, focal point adjustment of the optical finder can be effected at low power consumption. By the invention according to claim 7, a diopter adjustment of the optical finder can be effected at low power consumption. By the invention according to claim 8, it is possible to achieve an expanded optical adjusting range within which adjustment is possible, since the optical adjustment is effected by a plurality of variable configuration mirrors.

By the invention according to claim 9, it is possible to accomplish a controlling method of imaging apparatus capable of achieving power saving, since electricity is conducted only in the case of specific modes where the conduction of electricity to the variable configuration mirror is required. By the invention according to claim 10, an increase in peak current can be prevented to increase battery life and at the same time it is possible to secure a stabilized change in the configuration of the variable configuration mirror even if battery voltage has become low, since the respective timings of the conduction of electricity to the image taking section variable configuration mirror and to the optical finder variable configuration mirror are controlled so that an overlap with each other thereof are avoided. By the invention according to claim 11, an increase in peak current can be prevented to an extent possible and it becomes possible to increase battery life even in the case where a plurality of units of variable configuration mirror are used for the image taking section or for the optical finder section.

By the invention according to claim 12, an increase in peak current can be more securely prevented and the battery life can be more securely increased even in the case where a plurality of units of variable configuration mirror are used for the image taking section or for the optical finder. By the invention according to claim 13, an increase in peak current can be prevented to an extent possible and it becomes possible to increase battery life in the controlling method of imaging apparatus where a plurality of units of variable configuration mirror are used for the image taking section or for the optical finder. By the invention according to claim 14, power saving of the imaging apparatus can be achieved, since electricity is conducted only in the case of those modes where the conduction of electricity to the variable configuration mirror is required.

By the invention according to claim 15, it is possible to accomplish an optical finder capable of preventing an increase in peak current and capable of increasing battery life. By the invention according to claim 16, an optical adjustment of the optical finder can be kept substantially unchanged for a predetermined time, since the conduction of electricity is controlled so as to retain the configuration of the reflecting surface of the variable configuration mirror to a predetermined configuration within a permissible range. By the invention according to claim 17, the configuration of the variable configuration mirror can be kept substantially unchanged while keeping power consumption to a lower level, since electricity is conducted at predetermined intervals to the variable configuration mirror. By the invention according to claim 18, the configuration of the variable configuration mirror can be kept substantially unchanged while keeping power consumption to a lower level and at the same time preventing an increase in peak current, since the respective electricity conduction periods to a plurality of configuration mirrors are controlled so as to avoid an overlap thereof. By the invention according to claim 19 or 20, the configuration of the variable configuration mirror to be used for the image taking section can be kept substantially unchanged in a more stabilized condition while achieving power saving.

By the invention according to claim 21, the imaging apparatus can be accomplished as capable of controlling variable power adjustment of the optical finder using a variable configuration mirror in connection with a variable power section of the image taking section, since the variable magnification of the variable configuration mirror to be used for the optical finder is controlled in accordance with an instruction of change in variable magnification to the variable power section of the image taking section. By the invention according to claim 22, the variable power adjustment of the optical finder can cover the entire variable power adjusting range of the image taking system so as to improve the convenience in use of the optical finder, since the maximum variable magnification of the variable configuration mirror to be used for the optical finder is set equal to the maximum variable magnification of the image taking section obtained by combining optical and electronic variable power sections. By the invention according to claim 23, an image having a view angle matching the image to be taken can be visually confirmed through the optical finder even at the time of electronic variable power operation, since the variable magnification of the variable configuration mirror to be used for the optical finder is controlled in accordance with the variable magnification obtained by totaling the variable magnifications respectively of the optical and electronic variable power sections of the image taking section. By the invention according to claim 24, power saving effect of the imaging apparatus can be improved, since a variable configuration mirror is used in the variable power section of the image taking section.

By the invention according to claim 25, it is possible to accomplish a controlling method in which an image having the same angle of view as the image to be taken can be visually confirmed through an optical finder even at the time an electronic variable power adjustment, since control is effected so that variable power adjustment of the variable configuration mirror to be used for the optical finder is effected in accordance with the variable magnification obtained by combining optical and electronic variable power sections of the image taking section. By the invention according to claim 26, the variable power adjustments based on movement of lens along its optical axis of the image taking section and of the optical finder can be effected at equal magnification so as to make easier a mechanically linked operation of the variable power control of the image taking section and of the optical finder, since the maximum variable magnification of the optical variable power section of the image taking system and the maximum variable magnification of the lens variable power adjusting section of the finder variable power section are set equal to each other. By the invention according to claim 27, since an electronic variable power section for image to be taken is provided, a further enlargement of the image to be taken becomes possible and at the same time an image having a view angle matching the image to be taken can be visually confirmed through the optical finder even at the time of electronic variable power operation.

By the invention according to claim 28, since the image taking system optical variable power section and the finder variable power section are respectively constructed as a combination of lens variable power adjusting section and mirror variable power adjusting section and the maximum variable magnifications of the respective lens variable power adjusting sections are set equal to each other, the variable power adjustments by the respective lens variable power adjusting sections are effected at equal power so that a linked operation of structural variable power control can be readily effected between the image taking section and the optical finder. By the invention according to claim 29, since the image taking system optical variable power section and the finder variable power section are respectively constructed as a combination of lens variable power adjusting section and mirror variable power adjusting section and the maximum variable magnifications of the respective mirror variable power adjusting sections are set equal to each other, the variable power adjustments by the respective mirror variable power adjusting sections are effected at equal power so that a linked operation of variable power control can be readily effected between the image taking section and the optical finder. By the invention according to claim 30, it is possible to accomplish the imaging apparatus having an optical finder which consumes less power and provides a favorably adjusted view, since the variable configuration mirror for effecting focal point adjustment of the optical finder is controlled based on an outcome of focusing by the focus detecting section.

By the invention according to claim 31, a focal point adjustment can be effected at the time of a variable power adjustment of the optical finder so that an out-of-focus shift at the time of variable power of the optical finder can be effectively corrected. By the invention according to claim 32, a further power saving of the imaging apparatus can be achieved, since a variable configuration mirror is used at the image taking focusing section for adjusting focal point of the image taking section. By the invention according to claim 33, a further reduction in power consumption can be achieved, since electricity is not conducted to the variable configuration mirror of the optical finder so as not to effect a focal point adjustment thereof in the case where a through image is displayed on the image display section and use of the optical finder is unnecessary. By the invention according to claim 34, a yet further reduction in power consumption can be achieved, since control is effected during detection of focus so as to interrupt operation of the variable configuration mirror of the optical finder of which the operation is unnecessary. By the invention according to claim 35, it is possible to accomplish the imaging apparatus having an optical finder which consumes less power and provides a favorably adjusted view, since the variable configuration mirror for effecting focal point adjustment of the optical finder is controlled based on an outcome of focusing by the focus detecting means.

By the invention according to claim 36, it is possible to accomplish the imaging apparatus having a finder with a diopter adjusting function of reduced size and less power consumption in which diopter adjustment can be suitably and effectively effected based on stored information, since the variable configuration mirror for effecting the diopter adjustment of the finder is controlled in its configuration in accordance with information stored at a storage section. By the invention according to claim 37, the diopter adjustment of the finder can be controlled so as to be capable of corresponding to a plurality of photographers, since it is possible to store information according to a plurality of configurations of the variable configuration mirror. By the invention according to claim 38, it is possible to enter an image taking operation immediately after the turning ON of power, since the diopter adjustment of the finder is effected by stored information upon the turning ON of power.

By the invention according to claim 39, an efficient power saving effect can be obtained, since the diopter adjustment based on configuration control of the variable configuration mirror is effected when it is in a mode capable of taking images. By the invention according to claim 40, a visual confirmation of rough finder image becomes possible even when electricity is not conducted, since the diopter is adjusted to a standard diopter by the variable configuration mirror in the condition where electricity is not conducted. By the invention according to claim 41, a further reduction in power consumption can be achieved at low costs, since an optical finder is used as the finder. By the invention according to claim 42, a clearer image can be visually confirmed by focal point adjustment of the finder, since the variable configuration mirror for effecting the diopter adjustment of the finder is designed to also adjust focal point of the finder.

By the invention according to claim 43 or 44, a variable power image having a view angle matching the view angle of the image to be taken can be visually confirmed through the finder, since the finder has a plurality of variable configuration mirrors so as to be capable of effecting a variable power adjustment corresponding to the variable power adjustment of the image taking system. By the invention according to claim 45 or 46, the variable power ratio of the variable power image of the finder can be made greater and at the same time a variable power image having less aberration can be visually confirmed, since the configurations of a plurality of variable configuration mirrors of the finder are adjusted so as to be respectively brought to opposite direction from each other into a concave and a convex. By the invention according to claim 47, it is possible to accomplish an imaging apparatus having a finder with a diopter adjusting function of reduced size and less power consumption in which a diopter adjustment can be suitably and efficiently effected based on stored information, since the variable configuration mirror for effecting diopter adjustment of the finder is controlled in its configuration in accordance with information stored at a storage means. By the invention according to claim 48, it is possible to accomplish a finder with a diopter adjusting function of reduced size and less power consumption in which diopter adjustment can be suitably and effectively effected based on stored information, since the variable configuration mirror for effecting the diopter adjustment is controlled in its configuration in accordance with information stored at a storage section.

By the invention according to claim 49, it is possible to accomplish the finder through which a rough image can be visually confirmed even when electricity is not conducted, since the diopter is adjusted to a standard diopter by the variable configuration mirror in the condition where electricity is not conducted. By the invention according to claim 50, it is possible to give a warning that use of the finder is unsuitable, since the variable configuration mirror is controlled so that an unsuitable diopter different from the diopter at the time of using the finder is attained when use of the finder is to be avoided. By the invention according to claim 51, an image taking in which a parallax occurs can be effectively prevented, since the finder is controlled so as to result in an unsuitable diopter when the image taking distance is short after the setting of a macro mode or after AF. By the invention according to claim 52, it is possible to effectively prevent an image taking in which a difference occurs between the finder view angle and the image taking view angle, since the finder is controlled so as to result in an unsuitable diopter when image is to be taken by using an electronic zoom means.

By the invention according to claims 53 to 56, it is possible to accomplish an optical apparatus in which an increase in peak current can be prevented to increase battery life. By the invention according to claims 57 to 60, it is possible to accomplish an optical apparatus having a variable power function capable of achieving a reduction in power consumption, since it is provided with a lens variable power section and a mirror variable power adjusting section.

What is claimed is:

1. An imaging apparatus for taking image, said imaging apparatus comprising:
an optical finder for visually confirming the image to be taken;
a variable configuration mirror having a reflecting surface variable in configuration upon a conduction of electricity for performing an optical adjustment of said optical finder based on change in the configuration of the reflecting surface; and
a control section for effecting control so as to conduct electricity to said variable configuration mirror when an operation mode of said imaging apparatus is set to a specific mode.

2. The imaging apparatus according to claim 1, wherein said control section effects control so as to conduct electricity to said variable configuration mirror in accordance with predetermined instructions when the operation mode of said imaging apparatus is set to an image taking mode.

3. The imaging apparatus according to claim 1, wherein said control section effects control so as not to conduct electricity to said variable configuration mirror when the operation mode of the imaging apparatus is set to a through image displaying mode for displaying a through image onto an image display section.

4. The imaging apparatus according to claim 1, wherein said variable configuration mirror comprises a part of an optical system of said optical finder.

5. The imaging apparatus according to claim 1, wherein said variable configuration mirror adjusts a variable power ratio of said optical finder.

6. The imaging apparatus according to claim 1, wherein said variable configuration mirror adjusts a focal point of said optical finder.

7. The imaging apparatus according to claim 1, wherein said variable configuration mirror adjusts a diopter of said optical finder.

8. The imaging apparatus according to claim 1, wherein a plurality of units of said variable configuration mirror are provided to effect the optical adjustment of the optical finder.

9. A controlling method of imaging apparatus for taking image, said controlling method of imaging apparatus comprising a step of conducting electricity to a variable configuration mirror for performing an optical adjustment of an optical finder based on configuration change of a reflecting surface thereof due to conduction of electricity when an operation mode of the imaging apparatus is being set to a specific mode.

10. An imaging apparatus comprising:
an image taking section for taking image;
a variable configuration mirror to be used for the image taking section having a reflecting surface variable in configuration upon a conduction of electricity for performing an optical adjustment of said image taking section by change in the configuration of the reflecting surface;
an optical finder for visually confirming the image to be taken;
a variable configuration mirror to be used for the optical finder having a reflecting surface variable in configuration upon a conduction of electricity for performing an optical adjustment of said optical finder by change in the configuration of the reflecting surface; and
a control section for effecting control so as to avoid a reciprocal overlap of timings at which electricity is conducted respectively to the variable configuration mirror to be used for said image taking section and to the variable configuration mirror to be used for said optical finder.

11. An imaging apparatus comprising:
an image taking section for taking image;
a variable configuration mirror to be used for the image taking section having a reflecting surface variable in configuration upon a conduction of electricity for performing an optical adjustment of said image taking section by change in the configuration of the reflecting surface;
an optical finder for visually confirming the image to be taken;
a variable configuration mirror to be used for the optical finder having a reflecting surface variable in configuration upon a conduction of electricity for performing an optical adjustment of said optical finder by change in the configuration of the reflecting surface; and
a control section for, in controlling the conduction of electricity to the variable configuration mirror for said image taking section and to the variable configuration mirror for said optical finder, effecting control so as to avoid an overlap of the conduction of electricity for at least one variable configuration mirror of said variable configuration mirrors with the conduction of electricity for the other variable configuration mirror.

12. The imaging apparatus according to claim 11, wherein said control section effects control so that the conduction of electricity for each of all of said variable configuration mirrors does not overlap that for another.

13. A controlling method of imaging apparatus comprising a step of controlling a plurality of variable configuration mirrors that are variable configuration mirrors to be used for an image taking section for performing an optical adjustment of the image taking section by change in configuration of a reflecting surface caused by a conduction of electricity and variable configuration mirrors to be used for an optical finder for performing an optical adjustment of the optical finder by change in configuration of a reflecting surface caused by the conduction of electricity such that the conduction of electricity for at least one variable configuration mirror of the plurality of variable configuration mirrors does not overlap the conduction of electricity for the other configuration mirrors.

14. An imaging apparatus for taking image, said imaging apparatus comprising:
an optical finder for visually confirming the image to be taken;
a variable configuration mirror having a reflecting surface variable in configuration upon a conduction of electricity for performing an optical adjustment of said optical finder by change in the configuration of the reflecting surface; and
control means for effecting control so as to conduct electricity to said variable configuration mirror when an operation mode of said imaging apparatus is set to a specific mode.

15. An optical finder for visually confirming image to be taken, said optical finder comprising:
a plurality of variable configuration mirror having a reflecting surface variable in configuration upon a conduction of electricity for performing an optical adjustment by change in the configuration of the reflecting surface; and
a control section for controlling the conduction of electricity so that the periods during which electricity is conducted respectively to the plurality of variable configuration mirrors do not overlap each other.

16. An optical finder for visually confirming an image to be taken, said optical finder comprising:
a variable configuration mirror to be used for the optical finder constituting a part of an optical system of the optical finder and having a reflecting surface variable in configuration upon a conduction of electricity for performing an optical adjustment by change in the configuration of the reflecting surface; and
a control section for controlling the conduction of electricity so as to retain the configuration of the reflecting surface to be changed in configuration upon the conduction of electricity of the variable configuration mirror to a predetermined configuration within a permissible range.

17. The optical finder according to claim 16, wherein said control section effects control so as to conduct electricity to said variable configuration mirror at predetermined intervals to retain the configuration of the reflecting surface to a predetermined configuration within a permissible range.

18. The optical finder according to claim 16 comprising a plurality of said variable configuration mirror, wherein said control section controls the conduction of electricity so that the periods during which electricity is conducted respectively to the plurality of said variable configuration mirrors do not overlap each other.

19. An imaging apparatus comprising:
an image taking section for taking image;
a variable configuration mirror to be used for the image taking section having a reflecting surface variable in configuration upon a conduction of electricity for performing an optical adjustment of said image taking section by change in the configuration of the reflecting surface;
an optical finder for visually confirming the image to be taken;
a variable configuration mirror to be used for the optical finder having a reflecting surface variable in configuration upon a conduction of electricity for performing an optical adjustment of said optical finder by change in the configuration of the reflecting surface; and
a control section for controlling the conduction of electricity to the variable configuration mirror to be used for said image taking section and to the variable configuration mirror to be used for the optical finder;
wherein the control section effects control so that an intermittent conduction of electricity for retaining the configuration of the reflecting surface of said variable configuration mirrors to a predetermined configuration within a permissible range is repeated in such a manner that an intermittent cycle for the variable configuration mirror to be used for said image taking section is shorter as compared to that for the variable configuration mirror to be used for said optical finder.

20. An imaging apparatus comprising:
image taking means for taking image;
a variable configuration mirror to be used for the image taking means having a reflecting surface variable in configuration upon a conduction of electricity for performing an optical adjustment of said image taking means by change in the configuration of the reflecting surface;
an optical finder for visually confirming image to be taken;
a variable configuration mirror to be used for the optical finder having a reflecting surface variable in configuration upon a conduction of electricity for performing an optical adjustment of said optical finder by change in the configuration of the reflecting surface; and
control means for controlling the conduction of electricity to the variable configuration mirror to be used for said image taking means and to the variable configuration mirror to be used for the optical finder;
wherein the control means effects control so that an intermittent conduction of electricity for retaining the configuration of the reflecting surface of said variable configuration mirrors to a predetermined configuration within a permissible range is repeated in such a manner that an intermittent cycle for the variable configuration mirror to be used for said image taking means is shorter as compared to that for the variable configuration mirror to be used for said optical finder.

21. An imaging apparatus comprising:
an image taking section having a variable power section;
a variable power instructing section for giving an instruction for change in variable magnification to said variable power section;
an optical finder for visually confirming an image to be taken;
a variable configuration mirror to be used for the optical finder having a reflecting surface variable in configuration upon a conduction of electricity for performing a variable power adjustment by change in the configuration of the reflecting surface; and
a control section for controlling a variable magnification of the variable configuration mirror to be used for said optical finder in accordance with an instruction of said variable power instructing section.

22. The imaging apparatus according to claim 21, wherein the variable power section of said image taking section has an optical variable power section and an electronic variable power section and a maximum variable magnification of the variable configuration mirror to be used for said optical finder is set equal to a maximum variable magnification of the image taking section obtained by combining said electronic variable power section to said optical variable power section.

23. The imaging apparatus according to claim 21, wherein the variable power section of said image taking section has an optical variable power section and an electronic variable power section and said control section controls a variable magnification of the variable configuration mirror to be used for said optical finder in accordance with a variable magnification obtained by totaling the respective variable magnifications of said optical variable power section and said electronic variable power section.

24. The imaging apparatus according to claim 21, wherein the variable power section of said image taking section has a variable configuration mirror having a reflecting surface variable in configuration upon a conduction of electricity so as to perform a variable power adjustment by change in the configuration of said reflecting surface of the variable configuration mirror.

25. A controlling method of imaging apparatus including an image taking section having an optical variable power section and an electronic variable power section and an optical finder for visually confirming image to be taken, said controlling method of imaging apparatus comprising the steps of:
controlling the variable power of said image taking section by combining said optical variable power section and said electronic variable power section in accordance with an instruction of change in a variable magnification to said image taking section; and
controlling, in accordance with said combined variable magnification of the image taking section, a variable magnification of a variable configuration mirror provided in said optical finder having a reflecting surface variable in configuration upon a conduction of electricity for performing a variable power adjustment by change in the configuration of the reflecting surface.

26. An imaging apparatus comprising:
an image taking section for taking image;
a taking system optical variable power section for adjusting variable magnification of a image to be taken by movement of at least one lens along an optical axis thereof;
an optical finder for visually confirming the image to be taken; and
a finder variable power section for changing a magnification of said image to be visually confirmed, formed as a combination of two variable power adjusting sections that are a lens variable power adjusting section based on movement of a lens along the optical axis thereof and a mirror variable power adjusting section based on change in configuration of a reflecting surface of a variable configuration mirror having said reflecting surface variable in configuration upon a conduction of electricity;
wherein a maximum variable magnification of said taking system optical variable power section is set equal to a maximum variable magnification of the lens variable power adjusting section of said finder variable power section.

27. The imaging apparatus according to claim 26 further comprising an electronic variable power section which electronically changes a magnification of the image to be taken and of which a maximum variable magnification is set equal to a maximum variable magnification of said mirror variable power adjusting section.

28. An imaging apparatus comprising:
an image taking section for taking image;
a taking system optical variable power section for changing a magnification of said image to be taken, formed as a combination of two variable power adjusting sections that are a lens variable power adjusting section based on movement of a lens along an optical axis thereof and a mirror variable power adjusting section based on change in configuration of a reflecting surface of a variable configuration mirror having said reflecting surface variable in configuration upon a conduction of electricity;
an optical finder for visually confirming image to be taken; and
a finder variable power section for changing a magnification of said image to be visually confirmed, formed as a combination of two variable power adjusting sections that are a lens variable power adjusting section based on movement of a lens along an optical axis thereof and a mirror variable power adjusting section based on change in configuration of a reflecting surface of a variable configuration mirror having said reflecting surface variable in configuration upon a conduction of electricity,
wherein a maximum variable magnifications of the respective lens variable power adjusting sections of said taking system optical variable power section and said finder variable power section are set to be equal to each other.

29. An imaging apparatus comprising:
an image taking section for taking image;
a taking system optical variable power section for changing a magnification of said image to be taken, formed as a combination of two variable power adjusting sections that are a lens variable power adjusting section based on movement of a lens along an optical axis thereof and a mirror variable power adjusting section based on change in configuration of a reflecting surface of a variable configuration mirror having said reflecting surface variable in configuration upon a conduction of electricity;
an optical finder for visually confirming the image to be taken; and
a finder variable power section for changing a magnification of said image to be visually confirmed, formed as a combination of two variable power adjusting sections that are a lens variable power adjusting section based on movement of a lens along an optical axis thereof and a mirror variable power adjusting section based on change in configuration of a reflecting surface of a variable configuration mirror having said reflecting surface variable in configuration upon a conduction of electricity;
wherein a maximum variable magnifications of the respective mirror variable power adjusting sections of said taking system optical variable power section and said finder variable power section are set to be equal to each other.

30. An imaging apparatus comprising:
an image taking section for taking image;
a focus detecting section for effecting focus detection;
a taking focus section for adjusting a focal point of said image taking section;
an optical finder for visually confirming the image to be taken;
a variable configuration mirror having a reflecting surface variable in configuration upon a conduction of electricity for adjusting a focal point of said optical finder by change in the configuration of the reflecting surface; and
a control section for controlling the taking focus section and the variable configuration mirror based on an outcome of said focus detection.

31. The imaging apparatus according to claim 30, wherein said control section controls said variable configuration mirror so as to additionally effect a variable power adjustment of said optical finder.

32. The imaging apparatus according to claim 30, wherein said taking focus section has a variable configuration mirror having a reflecting surface variable in configuration upon conduction of electricity so as to adjust the focal point by change in the configuration of said reflecting surface of the variable configuration mirror.

33. The imaging apparatus according to claim 32 further comprising an image display section for electrically displaying the image to be taken, wherein, if a through image is being displayed on said image display section, said control section effects control so as to adjust the focal point only of the variable configuration mirror of said taking focus section and does not effect a focal point adjustment of the variable configuration mirror of said optical finder.

34. The imaging apparatus according to claim 33, wherein said focus detecting section detects focus by a contrast detection method, and said control section, during the focus detection by said focus detecting section, effects control so as to change the focal point adjustment of said taking focus section in connection with the focus detection and to cause the operation of the variable configuration mirror of said optical finder to be interrupted.

35. An imaging apparatus comprising:
image taking means for taking image;
focus detecting means for effecting focus detection;
taking focus means for adjusting a focal point of said image taking means;
an optical finder for visually confirming the image to be taken;
a variable configuration mirror having a reflecting surface variable in configuration upon a conduction of electricity for adjusting a focal point of said optical finder by change in the configuration of the reflecting surface; and
control means for controlling the taking focus means and the variable configuration mirror based on an outcome of said focus detection.

36. An imaging apparatus comprising:
an image taking section for taking image;
a finder for visually confirming the image to be taken;
a variable configuration mirror having a reflecting surface variable in configuration upon a conduction of electricity capable of adjusting diopter of said finder by change in the configuration of the reflecting surface;
a storage section for storing an information relating to the configuration of said variable configuration mirror corresponding to said diopter adjustment; and
a control section for controlling said variable configuration mirror to a predetermined configuration in accordance with said stored information.

37. The imaging apparatus according to claim 36, wherein said storage section stores information relating to a plurality of configurations as the information relating to the configuration of said variable configuration mirror.

38. The imaging apparatus according to claim 36, wherein said control section controls said variable configuration mirror to a predetermined configuration based on the stored information in accordance with a turning ON of a power supply of the imaging apparatus.

39. The imaging apparatus according to claim 36, wherein said control section controls said variable configuration mirror to a predetermined configuration based on the stored information when the imaging apparatus is in a mode capable of taking image.

40. The imaging apparatus according to claim 36, wherein a diopter condition of said finder is brought to a standard diopter condition by the reflecting surface configuration of said variable configuration mirror in a condition where electricity is not conducted.

41. The imaging apparatus according to claim 36, wherein said finder comprises an optical finder.

42. The imaging apparatus according to claim 41, wherein said variable configuration mirror, at the same time of diopter adjustment, adjusts a focal point of said finder in accordance with a focal point adjustment of an image taking optical system provided at said image taking section.

43. The imaging apparatus according to claim 41, wherein said finder has a plurality of variable configuration mirrors so that a variable power adjustment of said finder can be effected in accordance with a variable power adjustment of an image taking optical system provided at said image taking section.

44. The imaging apparatus according to claim 42, wherein said finder has a plurality of variable configuration mirrors so that a variable power adjustment of said finder can be effected in accordance with a variable power adjustment of an image taking optical system provided at said image taking section.

45. The imaging apparatus according to claim 43, wherein the mirror configurations of said plurality of variable configuration mirrors are respectively adjusted toward opposite direction from each other into a concave or into a convex.

46. The imaging apparatus according to claim 44, wherein the mirror configurations of said plurality of variable configuration mirrors are respectively adjusted toward opposite direction from each other into a concave or into a convex.

47. An imaging apparatus comprising:
an image taking means for taking image;
a finder for visually confirming image to be taken;
a variable configuration mirror having a reflecting surface variable in configuration upon a conduction of electricity capable of a diopter adjustment of said finder by change in the configuration of the reflecting surface;
storage means for storing information relating to the configuration of said variable configuration mirror corresponding to said diopter adjustment; and
control means for controlling said variable configuration mirror to a predetermined configuration in accordance with said stored information.

48. A finder for visually confirming image, said finder comprising:
a variable configuration mirror having a reflecting surface variable in configuration upon a conduction of electricity capable of a diopter adjustment of said finder by change in the configuration of the reflecting surface;
a storage section for storing an information relating to the configuration of said variable configuration mirror corresponding to said diopter adjustment; and
a control section for controlling said variable configuration mirror to a predetermined configuration in accordance with said stored information.

49. A finder for visually confirming image, said finder comprising a variable configuration mirror having a reflecting surface variable in configuration upon a conduction of electricity capable of a diopter adjustment of said finder by change in the configuration of said reflecting surface, wherein the diopter condition of said finder is brought to a standard diopter condition by the reflecting surface configuration of said variable configuration mirror in a condition where electricity is not conducted.

50. An imaging apparatus comprising:
an image taking section for taking image;
a finder for visually confirming image to be taken;
a variable configuration mirror having a reflecting surface variable in configuration upon a conduction of electricity capable of a diopter adjustment of said finder by change in the configuration of the reflecting surface; and
a control section for causing the configuration of the variable configuration mirror to be changed;
wherein the control section, when use of said finder is to be avoided, controls said variable configuration mirror so as to attain an unsuitable diopter thereof that is different from the diopter at the time of using the finder.

51. The imaging apparatus according to claim 50, wherein said control section effects control so as to result in said unsuitable diopter when an object distance in image taking is short.

52. The imaging apparatus according to claim 50, wherein said control section effects control so as to result in said unsuitable diopter at the time of taking an image by using an electronic zoom section.

53. An optical apparatus comprising:
a plurality of variable configuration mirror having a reflecting surface variable upon a conduction of electricity for performing an optical adjustment by change in the configuration of the reflecting surface; and
a control section for controlling the conduction of electricity so that the periods during which electricity is conducted respectively to the plurality of variable configuration mirrors do not overlap each other.

54. The optical apparatus according to claim 53, wherein the optical apparatus comprises an imaging apparatus for taking an image of object.

55. The optical apparatus according to claim 53, wherein the optical apparatus comprises an observing apparatus for observing a subject.

56. The optical apparatus according to claim 53, wherein the optical apparatus comprises an image forming apparatus for forming an object image.

57. An optical apparatus comprising:
a lens variable power adjusting section for adjusting a magnification of an image to be formed by moving a lens or lens group; and
a mirror variable power adjusting section for adjusting a magnification by a configuration of a reflecting surface of a variable configuration mirror having the reflecting surface variable in the configuration upon a conduction of electricity.

58. The optical apparatus according to claim 57, wherein the optical apparatus comprises an imaging apparatus for taking an image of object.

59. The optical apparatus according to claim 57, wherein the optical apparatus comprises an observing apparatus for observing a subject.

60. The optical apparatus according to claim 57, wherein the optical apparatus comprises an image forming apparatus for forming an object image.
